(19) United States
(12) Patent Application Publication
(10) Pub. No.: US 2010/0175629 A1
(43) Pub. Date: Jul. 15, 2010

(54) SYSTEMS, APPARATUS AND DEVICES FOR USE IN ANIMAL STUDIES

(75) Inventor: James W. Garmon, Hampstead, MD (US)

Correspondence Address: EDWARDS ANGELL PALMER & DODGE LLP, P.O. BOX 55874, BOSTON, MA, 02205, US

(73) Assignee: THE JOHNS HOPKINS UNIVERSITY, Baltimore, MD (US)

(21) Appl. No.: 12/704,264

(22) Filed: Feb. 11, 2010

Related U.S. Application Data
(63) Continuation of application No. PCT/US2008/009986, filed on Aug. 22, 2008.
(60) Provisional application No. 60/965,762, filed on Aug. 22, 2007.
(60) Provisional application No. 60/965,732, filed on Aug. 22, 2007.
(60) Provisional application No. 60/965,746, filed on Aug. 22, 2007.
(60) Provisional application No. 60/993,113, filed on Sep. 10, 2007.

(51) Int. Cl. A01K 1/03; A01K 1/00

(52) U.S. Cl. 119/419; 119/420; 119/456; 119/421

(57) ABSTRACT

Featured are various devices, apparatuses and systems for use in connection with animal studies or experimentation as well as methods related thereto. Such devices, apparatuses and systems include a scalable animal enclosure that is easily customized for a given application; a scalable and easily customizable sound attenuation chamber that can be used with such an animal enclosure; an olfactory discrimination system which can quickly delivery an odor to an animal while minimizing the potential for ambient contamination and a leak-free water delivery apparatus that provides a mechanism for the experimenter to determine water consumption without handling the device.

This application is a continuation of PCT International Application No. PCT/US2008/009986, filed Aug. 22, 2008, which claims the benefit of U.S. Provisional Application Ser. No. 60/965,762 filed on Aug. 22, 2007; U.S. Provisional Application Ser. No. 60/965, 732 filed on Aug. 22, 2007, U.S. Provisional Application Ser. No. 60/965, 746 filed on Aug. 22, 2007 and U.S. Provisional Application Ser. No. 60/993,113 filed on Sep. 10, 2007, all of which applications are incorporated herein by reference in their entirety.

### STATEMENT REGARDING FEDERALLY-SPONSORED RESEARCH

The present invention was supported by grants from the National Institute of Health (NCRR/NIH), grant number P40-RR-017688. The U.S. Government may have certain rights to the present invention.

### FIELD OF INVENTION

The present invention relates to animal studies and more particularly to systems, devices and apparatuses that are utilized during such studies in connection with feeding and studying animals. Such systems, apparatuses, and devices include for example, animal enclosures, sound attenuation chambers, olfactory discrimination systems and water feeders for animals within an animal enclosure.

### BACKGROUND OF THE INVENTION

In general there are a number of areas in which animals, such as mice and rats, are used in connection with experimentation. Some examples include animal behavioral studies, clinical studies such as those to evaluate the effect and toxicity of new medicines, and carcinogenetic studies. The value of research using lab animals hinges on the ability to carry out the experiments in a tightly controlled environment. Diet, caging materials (e.g., cages and water bottles), and other environmental variables have the potential to create serious disruptions in animal studies.

In regards to animal enclosures, particularly those used in connection with animal behavioral studies, the enclosure is typically designed and constructed for a given application or one test scenario or one series of tests. Consequently, the enclosures tend to be expensive, generally difficult to modify after they are constructed, so they are not easily adaptable to other uses. In addition, such enclosures are typically designed for the size of the animal to be used for the particular test phase. Thus, there continues to be a need to develop animal enclosures that can be easily modified or adaptable for different uses as well as being of a design that allows the design to be scaled to the size of the animal for the intended use.

In animal testing, some animals show a particular sensitivity to ambient noise which can disrupt the testing program or provide a confounding factor(s). When one is working in a crowded laboratory or other such space, with multiple experiments and multiple animals, it can be extremely difficult to achieve conditions where the test animal(s) are not exposed to such external or ambient sounds/noise. Consequently, the animal may be located in a chamber that is configured to attenuate ambient noise. Also, as with the animal enclosures, conventional chambers are generally constructed for the intended test protocol and test animal. Thus, there continues to be a need for improvement to such chambers to improve on sound attenuation while not comprising the need for breathable air and for chambers that are easily designable and constructed for different size test animals.

Many tasks used in animal behavioral testing require complicated training procedures to teach the animal to perform responses that they are unfamiliar with. This training is a time consuming aspect of certain types of experiments and is often not of particular interest to the researcher in and of itself. One such type of experiments utilizes the natural propensity of rodents to investigate novel aspects of their environment using their sense of smell. In such, experiments, a rodent is exposed to the smell of a gas or the like having a particular odor or smell, which is then required to make a discrete behavioral response to such exposure. Conventional systems yield measures of behavior that are such as to be somewhat ambiguous. Also, conventional systems are cumbersome, not fully automated and have practical limits on the number of scents or smells limits that can be delivered and the speed on which such scents can be delivered and changed from one scent to another, as well as the adaptability of such systems to be easily modified to deliver other or different scents. Thus, there is a continuing need to develop olfactory types of system that take such advantage of the natural propensity of rodents to investigate novel aspects of their environment using their sense of smell which can provide measures of behavior that are less ambiguous than the measures yielded by conventional systems and which overcome all or most of the above-described shortcomings.

As indicated above, as part of animal experiments, it is frequently necessary to measure the amount of fluid (e.g., water) that an animal (e.g., mouse or rat) consumes over a short duration or the duration of the test protocol. Conventional products on the market, are not necessarily leak-proof which can lead to an over-estimation of the amount of fluid that was consumed. Also, such conventional products must be moved or disconnected from the enclosure and also can require that the product be turned over in order for the technician to be able to read or determine the amount of fluid that has been consumed by the animal. Thus, there continues to be a need for apparatuses or devices for delivering water that further minimize if not eliminate leakage thereby providing a device capable of making more accurate measurements of fluid consumption as well as devices that allow such measurements to be made without having to handle the device.

Some examples of prior art animal enclosures or cage systems are found in U.S. Pat. Nos. 3,397,676; 5,003,922 and 6,308,660. A cage for breeding experimental animals and a ventilation apparatus for a cage rack system is found in PCT Publication No. WO/02/1153. The PheComp system of Panlab is a conventional system that is configured for use in studying the compulsive food and drink behaviors in rodents.

It thus would be desirable to provide new systems, apparatuses and devices, as well as methods related thereto, for the care of experimental animals and testing or study of such experimental animals. It would be particularly desirable to provide an animal enclosure that can be easily modified or adapted for different uses as well as being of a design that allows the design to be scaled to the size of the animal in comparison to prior art devices. It would be particularly desirable to provide a sound attenuation chamber that improves on sound attenuation while not comprising the need for breathable air and for chambers that are easily designable and constructed for different size test animals in comparison to prior art chambers. It would be particularly desirable to provide an olfactory discrimination system that takes advantage of the natural propensity of rodents to investigate novel aspects of their environment using their sense of smell and which can provide measures of behavior that are less ambiguous than the measures yielded by prior art systems as well as overcoming a number of shortcomings of such prior art systems. It would be particularly desirable to provide an animal water delivery device or apparatus that is capable of making more accurate measurements of fluid consumption as compared to prior art devices as well as minimizing or eliminating the need to handle the device to make such measurements as is required with prior art devices. Such collection systems, apparatuses and devices preferably would be less costly than prior art devices and such methods would not require highly skilled users to utilize the device.

### SUMMARY OF THE INVENTION

The present invention features various device, apparatuses and systems for use in connection with animal studies or experimentation as well as methods related thereto. Such devices, apparatuses and systems include a scalable animal enclosure that is easily customized for a given application; a scalable and easily customizable sound attenuation chamber that can be used with such an animal enclosure; an olfactory discrimination system which can quickly delivery an odor to an animal while minimizing the potential for ambient contamination and a leak-free water delivery device that provides a mechanism for the experimenter to determine water consumption without handling the device.

According to one aspect of the present invention, there is featured a scalable animal enclosure that includes a frame made up of a plurality of scalable frame members that are interconnected to each other and a plurality of wall members. Each of the plurality of scalable frame members include a connecting mechanism configured so as to releasably secure an end portion of an adjacent wall member. Each wall member is secured to an adjacent pair of wall members so as to thereby form a wall of the animal enclosure.

According to another aspect of the present invention there is featured, a sound attenuation chamber that includes a frame having a plurality of scalable frame members that are interconnected to each other; and a plurality of panel members. Each of the plurality of scalable frame members includes a connecting mechanism that is configured so as to secure an end portion of a panel member. Also, each of the plurality of panel members is configured so as to include a plurality of layers of materials having different densities that when attached to each other creates a panel that attenuates sound external to the chamber. In further embodiments, each of the plurality of panels is configured to include at least three layers of material, the density of each layer being different from the other layers.

According to another aspect of the present invention, there is featured an olfactory discrimination system for selectively exposing an animal to one of a plurality of odors at a time. Such a system includes an odor delivery subsystem. Such an odor delivery sub-system includes a plurality of bottles, each containing a material(s) for generating an odor and a delivery device that is configured to selectively deliver a specific odor from one of the plurality of bottles to the animal. The delivery device includes a delivery line and a bypass line that is operably coupled to the delivery line. The delivery device also is configured so that the bypass line is selectively coupled to a vacuum source so flow of the odor through the delivery line occurs when the bypass line is fluidly coupled to the vacuum source and so the odor is delivered to the animal from the delivery line when the bypass line is fluidly de-coupled from the vacuum source.

In further embodiments, such an olfactory discrimination system further includes a means for providing a continuous source of gas, where the continuous gas source means is fluidly coupled to the delivery line. Also the delivery device is further configured so that the continuous gas source means is coupled to the delivery line when the bypass line is open, when flow of odor through the delivery line occurs and when the odor is being delivered to the animal, and so that the gas continues to flow through the delivery line after flow of the odor to the animal is discontinued. In yet further embodiment, such an olfactory discrimination system includes N bottles. where N is an integer greater than 2 and in more specific embodiments, N is 16.

In yet further embodiments, such an olfactory discrimination system further includes a fluid delivery subsystem. Such a fluid delivery sub-system includes a plurality of bottles, each containing a different fluid; and a fluid delivery device configured to selectively deliver a specific fluid from one of the plurality of bottles to a watering device for the animal. Such a delivery device includes a plurality of delivery lines one for each bottle, a plurality of control devices one of said plurality of control devices being operably coupled to a respective one of the delivery lines, and a controller operably coupled to each of the control devices and which is configured so as to cause the respective control device, corresponding to the bottle having the fluid to be delivered, to operate so as to allow the fluid to flow from the bottle to the watering device.

According to another aspect of the present invention there is featured an apparatus for measuring the water consumed by an animal over time; such an apparatus includes a watering device; an indexed storage device configured to store a fluid and to include gradations representative of an amount of fluid therein; and a means for fluidly coupling the watering device to the indexed storage device. In further embodiments, the means for fluidly coupling includes an adaptor configured to couple with an end of the watering device and an end of the indexed storage device.

In yet further embodiments, the measuring apparatus further includes a quick disconnect including a first part and a second part that are selectively fluidly coupled and de-coupled from each other, and the means for coupling includes an adapter configured to selectively couple with an end of the watering device and one of an end of the first part or second part.

According to another aspect of the present invention, there is featured a method for determining an amount of fluid consumed by an animal comprising the steps of providing a watering apparatus including an indexed storage device configured to store a fluid and to include gradations representative of an amount of fluid in therein; and visually observing the indexed storage device and determining therefrom an amount of fluid consumed by the animal. In further embodiments, such visually observing does not involve the touching or the manipulating of the indexed storage device by a user.

There also is featured a method for selectively exposing an animal to one of a plurality of odors at a time, including the step of providing an odor delivery subsystem. Such a odor delivery sub-system includes a plurality of bottles, each containing a material(s) for generating an odor, a delivery device configured to selectively deliver a specific odor from one of the plurality of bottles to the animal, and the delivery device including a delivery line and a bypass line operably coupled to the delivery line. Such a method also includes coupling the bypass line to a vacuum source so flow of the odor through the delivery line occurs, and decoupling the bypass line from the vacuum source so the odor is delivered to the animal from the delivery line when the bypass line is fluidly de-coupled from the vacuum source.

In further embodiments, such a method includes providing a fluid delivery subsystem that includes a plurality of bottles, each containing a different fluid and a fluid delivery device configured to selectively deliver a specific fluid from one of the plurality of bottles to a watering device for the animal. Such a method also includes operating the fluid delivery device so that the fluid in the bottle having the fluid to be delivered flows from the bottle to the animal watering device.

Also featured is a method for making a sound attenuation chamber comprising the steps of creating a frame from a plurality of scalable frame members that are interconnected to each other; providing a plurality of panel members, each of the plurality of panel members is configured so as to include a plurality of layers of materials having different densities that when attached to each other creates a panel that attenuates sound external to the chamber; and connecting each of the plurality of frame members to adjacent pairs of scalable frame members so as to form at least five walls of the chamber.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIGS. 1(a), 1(b) are axonometric views of illustrative embodiments of a scalable animal enclosure according to the present invention;

FIG. 2 is another, enlarged axonometric view of the scalable animal enclosure of FIG. 1(b);

FIG. 3 is another, enlarged axonometric view of the scalable animal enclosure of FIG. 1(a);

FIG. 4 is a top of a scalable animal enclosure according to another illustrative embodiment of the present invention;

FIG. 5 is an illustrative view showing a stacked arrangement of a multiplicity of sound attenuation chambers according to the present invention;

FIG. 6 is a cross-sectional view of a corner portion of the sound attenuation chamber of FIG. 5;

FIG. 7 is a illustrative view showing the door and door sealing arrangement of the sound attenuation chamber of FIG. 5;

FIG. 8(a) is an illustrative view of a back wall of the sound attenuation chamber of FIG. 5, showing a portion of the air ventilation system;

FIG. 8(b) is an enlarged view of a portion of FIG. 8(a) showing the baffles;

FIG. 9 is another illustrative view of the back wall of the sound attenuation chamber of FIG. 5, showing another portion of the air ventilation system;

FIG. 10 is a partial view of a corner portion in the top or bottom surface of the sound attenuation chamber of FIG. 5, showing a feature by which the sound attenuation chamber can be stacked;

FIG. 11 is another illustrative view of the stacked arrangement shown in FIG. 5, but with the doors opened;

FIGS. 12(a),(b) include an illustrative front view (FIG. 12(a)) and an illustrative back view (FIG. 12(a)) of an olfactory discrimination system according to the present invention;

FIG. 13 is an illustrative front view of the olfactory discrimination system of FIG. 12 with the doors to the sound attenuation chambers opened;

FIG. 14 is an illustrative view of the interior of an opened sound attenuation chamber also showing the animal enclosure disposed therein;

FIG. 15(a) is an illustrative front view of a portion of the olfactory discrimination system of FIG. 12 showing the fluid storage and the flow control valves/meters that meter flow of the odor being delivered to the animal;

FIG. 15(b) is an enlarged view of FIG. 15(a) showing the fluid storage;

FIG. 16 is an illustrative back view of a portion of the olfactory discrimination system of FIG. 12 showing a portion of the sub-system for delivering the odor to the animal;

FIG. 17 is an illustrative view within the olfactory discrimination system of FIG. 12 showing a view of another portion of the sub-system for delivering the odor to the animal;

FIG. 18 is an illustrative view within the olfactory discrimination system of FIG. 12 showing a side view of a portion of the subsystem for delivering fluid to the animal;

FIG. 19 is an illustrative view of the individual fluid storage bottles of FIG. 15(b);

FIG. 20 is an illustrative view showing the fluid storage bottles connected to the inlets;

FIG. 21 is another of the bottle inlets but with the fluid storage bottles disconnected from the inlets;

FIG. 22 is a schematic block diagram view of the odor delivery sub-system;

FIG. 23 is a schematic block diagram view of the fluid delivery sub-system;

FIG. 24 is a illustrative view of a customized animal enclosure showing a side wall member configured with the animal nose poke and the fluid well area;

FIG. 25 is an illustrative view showing interconnections between the odor and fluid delivery sub-systems and the related features of the animal nose poke and the fluid well area;

FIGS. 26(a)-(b) are various illustrative elevation views of a part of a capillary licker according to embodiments of the present invention;

FIG. 26(c) is an illustrative view of a part of a capillary licker according to other embodiments of the present invention;

FIG. 26(d) is an illustrative view of a valve assembly portion of a capillary licker according to the present invention;

FIG. 27 is an illustrative view of a capillary licker according to the present invention;

FIG. 28 is partial illustrative view of a disassembled capillary licker according another embodiment of the present invention;

FIG. 29 is a schematic block view of the flow control valve/meter station on the front side of the olfactory discrimination device; and

FIG. 30 is an illustrative view of an exemplary odor cartridge.

### DESCRIPTION OF THE PREFERRED EMBODIMENT

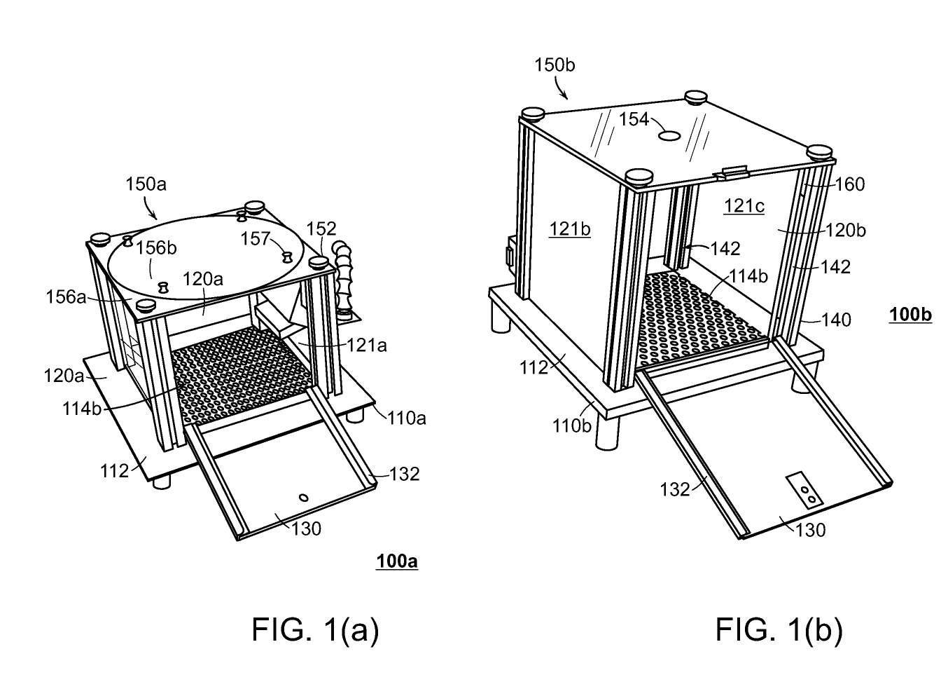

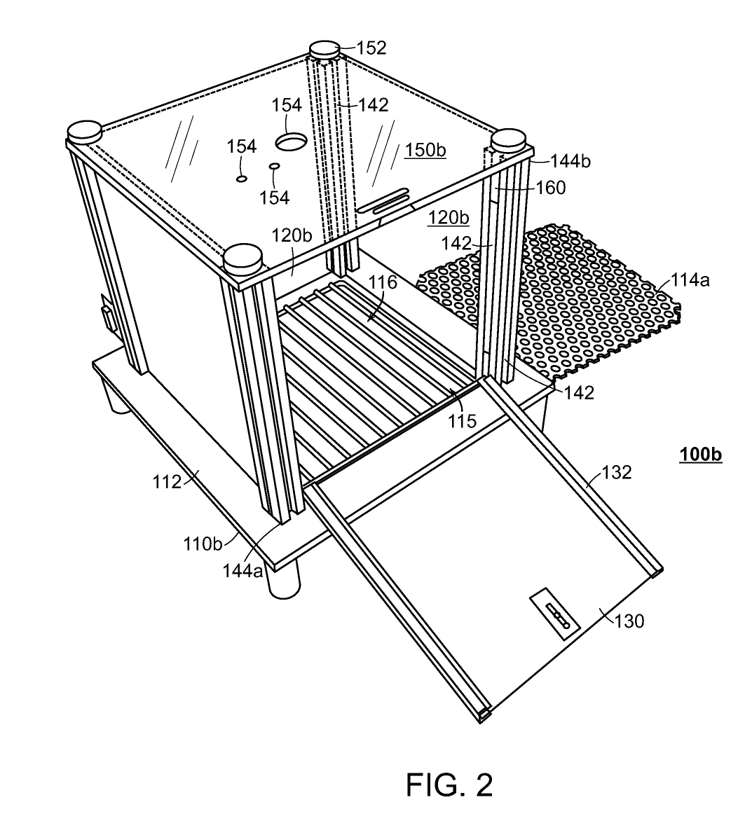

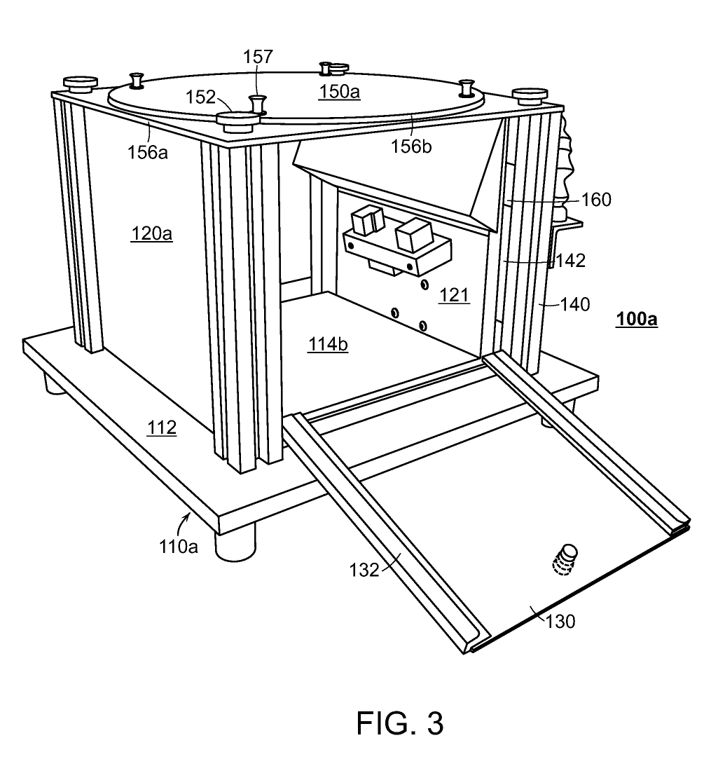

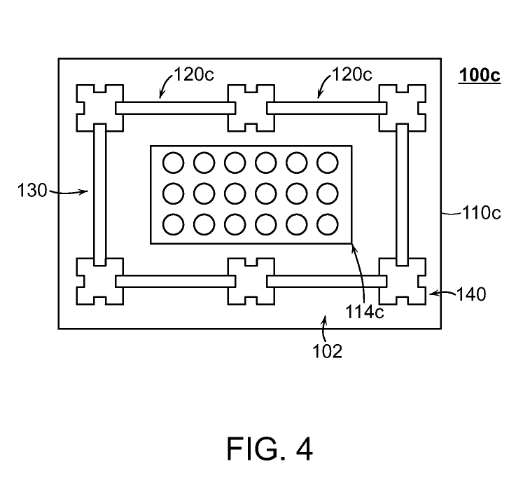

Referring now to the various figures of the drawing wherein like reference characters refer to like parts, there is shown in FIGS. 1(a), 1(b) axonometric views of illustrative embodiments of a scalable animal enclosure 100a,b according to the present invention. Also, there is shown in FIG. 2 an enlarged axonometric view of the scalable animal enclosure 100b of FIG. 1(b) and in FIG. 3 another, enlarged axonometric view of the scalable animal enclosure 100a of FIG. 1(a). There is shown in FIG. 4 a top view of yet another scalable animal enclosure 100c.

In the following discussion, when reference is made to a specific animal enclosure or a part of an animal enclosure that is specific to one of the illustrated animal enclosures, the reference numeral includes a numeric character and an alpha character (e.g., 100a,b, 110a,b). When reference is being made generally to any animal enclosure of the present invention or generally to a common but slightly different feature (e.g., base 110a,b) of the illustrated animal enclosure, then reference may be made to only the numeric character that is in common (e.g., base 110).

As can be seen from the following discussion, the animal enclosures 100a,b,c shown in these figures illustrate the adaptability or flexibility of the animal enclosure to be assembled so as to carry out any of a number of functions as well as the ease by which such an animal enclosure is scalable during the process of making and assembling such an animal enclosure of the present invention. Also, as hereinafter described in connection with another aspect of the present invention, such animal enclosures 100 are usually placed inside of a sound attenuation chamber, such as that described herein, or other enclosure in order to run experiments.

As shown in FIG. 1(a) and FIG. 3, an animal enclosure 100a according to one illustrative embodiment of the present invention includes a base member 110a; side wall members 120a; a front wall member 130; and a plurality of vertical fixed frame members 140. As shown in FIG. 1(b) and FIG. 2, an animal enclosure 100b according to another illustrative embodiment of the present invention includes a base member 110b; side wall members 120b; a front wall member 130; and a plurality of vertical fixed frame members 140. As shown in FIG. 4, an animal enclosure 100c according to another illustrative embodiment, includes a base member 110b; side wall members 120b; a front wall member 130; and a plurality of vertical fixed frame members 140, where one or more sides 102 of the animal enclosure 100c includes a plurality of side wall members.

The scalable animal enclosure 100 is particularly useful for experiments involving laboratory mice or other small laboratory animals. In one illustrative embodiment, the base member 110 includes a first base member 112 having a configuration that is appropriate for the intended use and also is constructed of a material suitable for the intended use. In particular embodiments, the first base member 112 is constructed from a plastic material. In addition, the shape of the first base member and its size is configurable to fit the intended use and can be in the shape of a rectangle, square circle, pentagon, hexagon, octagon and the like. In more specific embodiments, the shape of the first base member 112 is arranged to compliment the shape of the structure that extends vertically upwardly and is defined by the side wall members 120 the front wall member 130 and the vertical fixed frame members 140.

The first base member 112 is configurable with a through opening 115 that is located in a central portion of the first base member and being within the interior of the animal disclosure as defined by the side wall members 120 and the front wall member 130. The animal enclosure is further configurable so that a perforated member 114, such as a perforated plastic sheet 114b or a perforated metal sheet 114b, is disposed so as to extend over and beyond the boundaries of the centrally located through opening 115 so as thereby extend over the opening. In further embodiments, a plurality of rods 116 (metal or plastic) are arranged so as to extend across the centrally located through opening 115 and in more specific embodiments extend between the axially extending walls of the centrally located through opening. Alternatively, a sheet like member including such rods is provided which sheet like member is disposed so as to extend over and beyond the boundaries of the centrally located through opening 115 so as to extend over the opening. In further embodiments, the rods are arranged to provide a mesh like structure.

The perforated sheet members and rod structures described above, provide a support surface for the animal when it is located within the animal enclosure 100, to walk or rest upon. These members or structures also provide a mechanism that allows animal waste to fall through to a collection device (not shown) as is known in the art (e.g., a removable urine pan) that is located below the centrally located through opening 115 in the base member 110. The foregoing structures are illustrative and shall not be limiting as its is within the scope of the present invention for any structure or combination with the first base member as is known to those skilled in the to be utilized to form such a removable or fixed support structure or floor that is appropriate for the intended use.

The structure that extends upwardly from the base member 110, defines the outer vertical boundaries of the sides 102, or the enclosure or compartment in which the animal is located. This upwardly extending structure includes the side wall members 120 (which includes the back wall member), the front wall member 130 and the vertical frame members 140. An end 144a of each vertical frame member 140 is secured to the base member 110 so that the frame members are generally in fixed relation to the base member. Such securing can be accomplished using any of a number of means known to those skilled in the art including mechanical attachments (screws, bolts, nuts and adhesives).

In particular embodiments, the side wall members 120a,b are removably secured to each frame member 140 that abuts an end of a given side wall member. Thereby also securing the side walls in fixed relation to the base member 110. In further embodiments, the side walls are secured so that a bottom edge of the side walls abut the base member 110 or are spaced a distance from the base member such as to provide for ventilation.

In more specific embodiments, the frame members 140 are configured so as to include at least one slot 142 that extends vertically, preferably two such vertically extending slots, in which is slidably received a vertically extending end of a side wall member 120a,b. The slots 142 in the frame members 140 provide a mechanism by which the wall members 120a,b can be easily removed or replaced after the animal enclosure is assembled so as to allow one or more wall members that have been modified or customized for a given testing or experimental sequence to be inserted between adjacent frame members 140. For example, and as illustration, the side wall members 120 are configurable so as to be opaque 121b, clear 121c (e.g., to allow a camera or researcher to see through), a custom wall 121a with necessary scientific equipment (e.g., electronic components, fiber optics, lights, etc.), or a combination of the above as dictated by the needs and intents of the experiment to be performed.

Because of this flexibility, an animal enclosure 100 of the present invention can be modified as and when needed to fit the needs for multiple research purposes, which is in contrast to conventional animal enclosures that do not have such flexibility. As animal enclosures 100 are easily modified to fit different research purposes, research cost are reduced as compared to research where a one-off animal enclosure is used. Also, if a customized side wall member is not available for a given experiment, a customized wall member can be made for the given experiment and then used in combination with an existing animal enclosure, which again will lead to reduced costs as compared to the cost of an animal enclosure that is suitable only a given experiment.

In further embodiments, the frame members 140 further include one or more slots 142 or other structural feature (e.g., threaded aperture) that can serve as an attachment point for devices, or other equipment/structure that is mounted to the exterior surfaces of the animal enclosure, more specifically to one or more of the frame members 140 thereof.

The number of frame members 140 are defined by the general shape of the structure extending upwardly from the first base member 112, the size of the enclosure 100 and the number of side wall members 120 being used to define a side of the enclosure. In particular embodiments, each animal enclosure 100 includes a plurality of frame members 140, four or more frame members 140, and in illustrative embodiments, four frame members per animal enclosure.

In further embodiments, and with particular reference to FIG. 4, an animal enclosure 100 of the present invention is configurable so that one or more sides 102 thereof, more particularly two sides, of the animal enclosure are arranged to include a plurality of side wall members 120c and one or more frame members 140 that are located between the frame members 140 disposed at intersections or corners of sides (including back and front walls). The one or more frame members being provided to couple each adjacent pair of side wall members 120c and also being coupled to the base member 110c including a perforated member 114c. The side wall members 120c are configurable so as to span the same lateral distance or as illustrated in FIG. 4, the side wall members are configurable so that each extend laterally a different amount (i.e., side wall members can have different widths).

In illustrative embodiments, the frame members 140 comprise four bars of 1″×1″ 80/20 T-slotted extruded aluminum, each bar forming a frame member for the animal enclosure. The slots in each of the frame members removably (e.g., slidably) receive the vertical extending sides of a side wall member 120 as described above.

The front wall member 130 of each animal enclosure 100 in particular embodiments is configured as the door for the animal enclosure that is releasably secured to the frame members 140 adjacent to the front wall or other structure of the animal enclosure (e.g., the top member 150) using any of a number of mechanisms or techniques known to those skilled in the art. In illustrative embodiments, the present invention utilizes a magnetic latch to secure the front wall 130 to the adjacent frame members 140.

In more particular illustrative embodiments, the vertical edges of the front wall member 130 include a metal surround, such as for example, a stainless steel U-channel frame 132 and magnets 160 are located in the slots 142 on opposing sides of the adjacent frame members 140 which create a magnetic field sufficient in strength to keep the animal inside the animal enclosure from pushing the front wall member open. In illustrative embodiments, the magnets 160 comprise two rare earth magnets and a neodymium magnet underneath each rare magnet.

In further embodiments, the animal enclosures 100a,b also can include a top member 150a,b. The top member 150 is secured to the frame members 140 using any of a number of means known to those skilled in the art. In illustrative embodiments the top member is secured mechanically to the frame members 140 using a threaded member (not shown) secured to the frame member and a nut 152.

As shown in FIG. 1(b), the top member 150 also is configurable so as to include one or more through apertures 154. As shown more clearly in FIG. 1(a), the top member 150 also is configurable so as to include a fixed part 156a and a removable part 156b, where the removable part 156b is removable secured to the fixed part 156 by screws (not shown) and nuts 157.

It should be recognized that when an animal enclosure 100 of the present invention is being initially constructed, the constructor adjusts the lengths of the frame members 140 and the heights and widths of the side wall members 120 and the front wall member 130 so as to create an enclosure that is appropriately sized for the animal. Also, the base member 110 size and shape can be easily determined from the design and size of the enclosure formed when the frame members 140, and side wall members 120 and front wall 130 are assembled and arranged on the surface of the base member. Thus, it can be seen that the basic structure being defined by these features of the animal enclosure of the present invention are easily scalable so as to construct animal enclosures for animals of different sizes and physical capabilities. As also indicated above, because side wall members of the present invention are easily removable and/or customizable, the constructor or a user in the field can easily replace one side wall member with another side wall member having different characteristics without requiring the disassembly of the entire animal enclosure. As discussed hereinafter, such an animal enclosure 100 is usable in combination with a sound attenuation chamber 200 of the present invention.

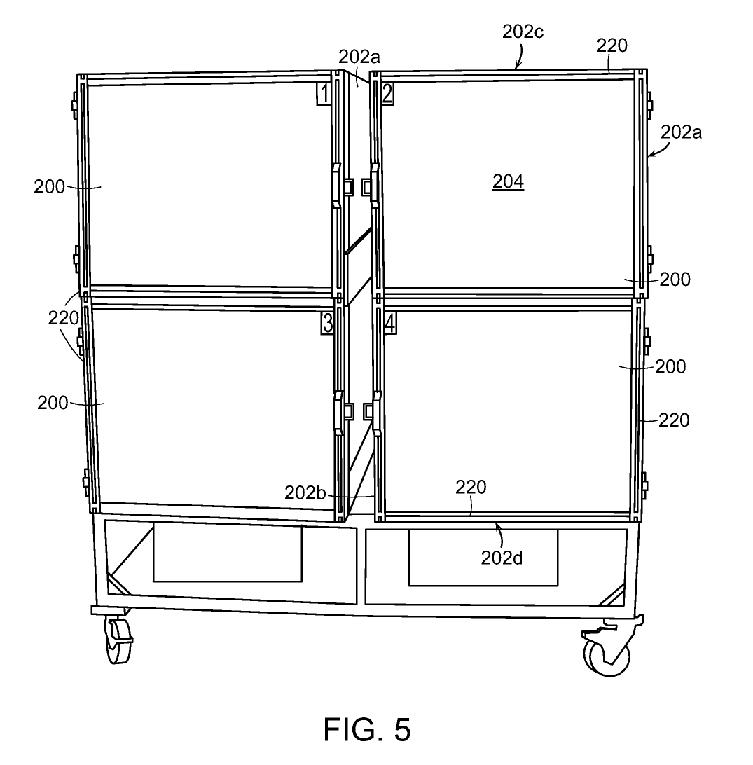

When working with mice or rats, many experiments require conditions under which the animals are not exposed to external sounds that may act as confounding factors. When working in a crowded laboratory, with multiple experiments and multiple animals, it can be extremely difficult to achieve such conditions. Referring now to FIGS. 5-11 there are shown various views of a sound attenuation chamber 200 according to the present invention which advantageously provides a sufficiently large environment to run complex animal experiments yet are also able to block out a vast majority of the ambient noise.

Referring now to FIG. 5, there is shown an illustrative view of a stacked arrangement of a multiplicity of sound attenuation chambers 200 according to the present invention. The sound attenuation chambers 200 of the present invention are configurable so as to take full advantage of available lab space. As shown in FIG. 5, the structure of such a sound attenuation chamber allows a large number of test systems enclosed in such chamber to be fully operational in close proximity, providing for economy of space and efficient use of personnel. Further, test systems within such a chamber can be easily re-configured within allocated space depending on demand and usage. Furthermore, all the walls 202 a-e, 204, including the door 204, are modular, allowing them to be easily customized and/or replaced.

Each sound attenuation chamber 200 is a relatively large, scalable enclosure including six walls 202a-e, 204, one of which acts as the door 204 for the sound attenuation chamber, and a plurality of frame members 220 that are configured and arranged to form a supporting frame to which the walls and door are attached.

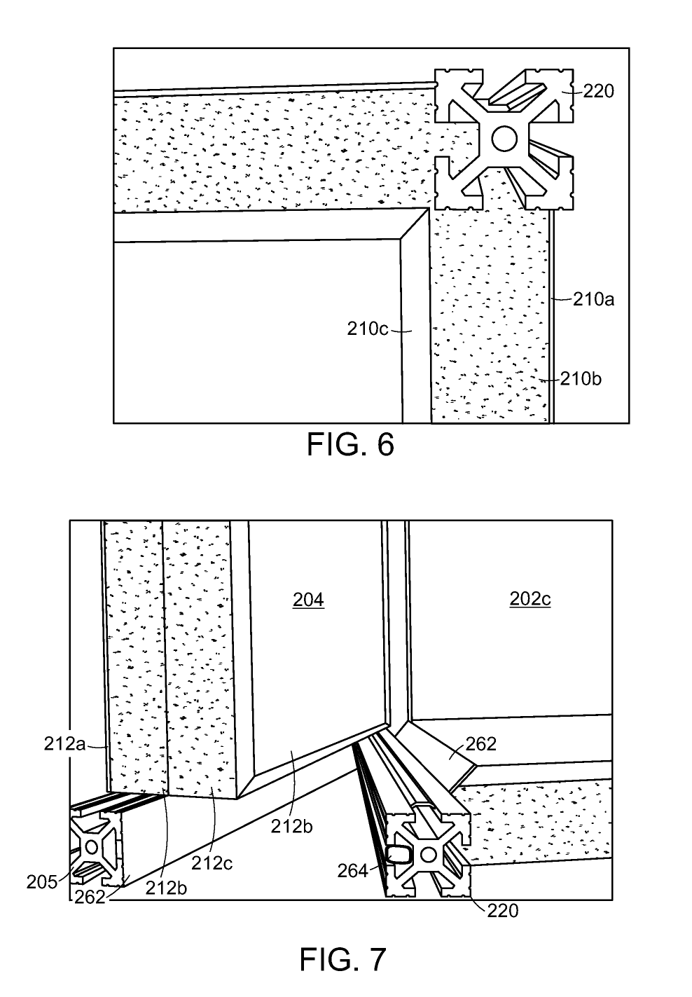

As shown more clearly in FIG. 6, each of the walls 202a-3, 204 includes three or more layers 210 a-c where at least three of the layers are composed of materials that have densities that vary from each other. In particular embodiments, the walls 202 a-e exclusive of the door 204 are composed of three layers and the door is composed of four layers. It should be recognized that the walls and door 202a-e, 204 are configurable so as to include any number of layers of sound attenuating materials so as to achieve a desired level of sound attenuation.

In illustrative embodiments, the walls 202a-e (excluding the door) are made of three layers of sound attenuating plastic sheets; more specifically an external or outer layer 210a of PVC Type I, a middle layer 210b of a water-resistant sound absorbing sheet (e.g., compressed, corrosion-resistant polypropylene beads), and an internal or inner layer 210c of expanded rigid PVC. In more particular illustrative embodiments, the walls 2020a-e are made from three materials: 1/16″ thick PVC Type I grey sheet, 0.236″ thick white expanded PVC sheet, and 1″ thick water-resistant sound absorbing sheet (polypropylene foam). The sheets are secure together using an adhesive material (e.g., 3M Aerosol Adhesive High Strength 90) with the Type I PVC on the outside, the polypropylene foam in the middle, and expanded PVC on the inside.

Once the walls 202a-e are prepared (e.g., adhesive has dried), the wall pieces are then configured for mating with the frame members 220. For example, the walls 202a-e are edged on all four sides (for example, using a table saw) so as to create a slight protrusion that extends from the middle layer 210b of polypropylene foam. Also, for example, the inside of the wall or the inner layer 202c (expanded PVC portion) is also edged on the table saw to a roughly 45 degree angle so as to allow the walls to internally overhang the frame members 220 slightly yet fit firmly together inside of the box. This thereby further limits if not prevents ambient noise from entering the box through the material making up the frame members 220. An inner layer 210c of expanded PVC is particularly advantageous because this material is nonporous and easily cleaned with standard laboratory products.

As to the remaining wall that forms the door 204 for the sound attenuation chamber 200, in illustrative embodiments the door is composed of four layers 212a-d and at least three of the layers are composed of materials having different densities. In more particular illustrative embodiments, the first layer 212a is composed of a material having a first density, the second and third layers 212 b,c are composed of a material having a second density that is different than the density of the first layer and the fourth layer 212 d is composed of a material having a third density that is different than the density of the first through third layers. In yet further illustrative embodiments, the external or first layer 212a is an external PVC Type I sheet, the second and third layers 212 b,c are sheets of polypropylene foam, and the fourth layer 212 d is a sheet of internal expanded PVC. For the door, the second layer 212b is configured for mating with the corresponding frame member 220. For example, the second layer 212 b is further processed so as to create a slight protrusion that extends from the second layer of polypropylene foam that engages with the frame member 220. The door 204 is otherwise manufactured or assembled as described above.

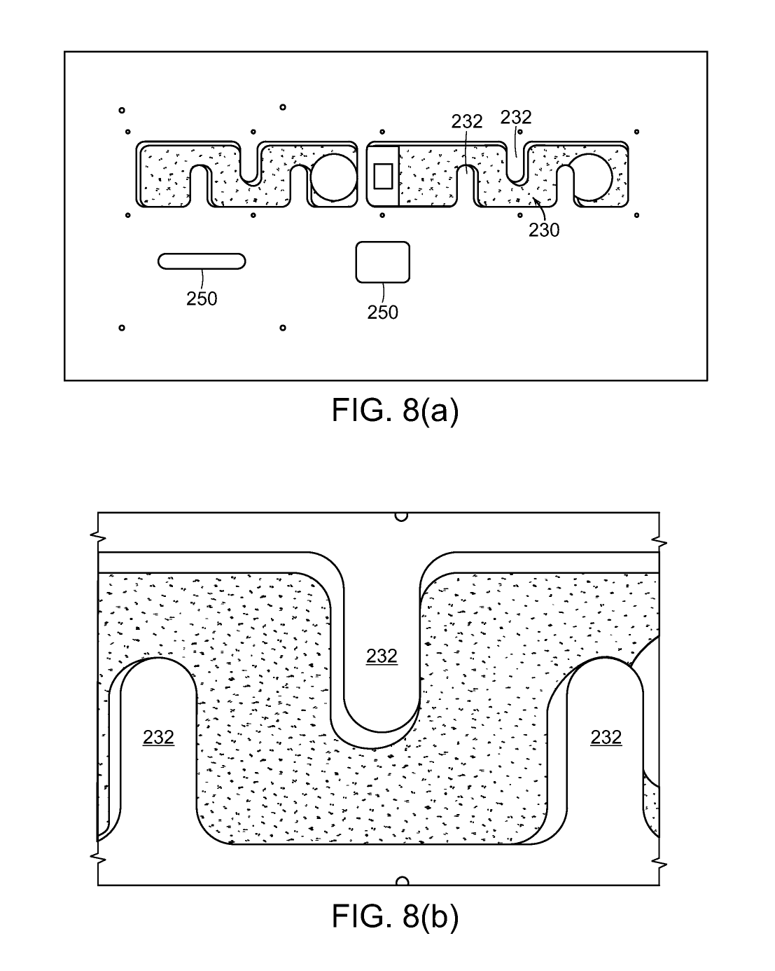

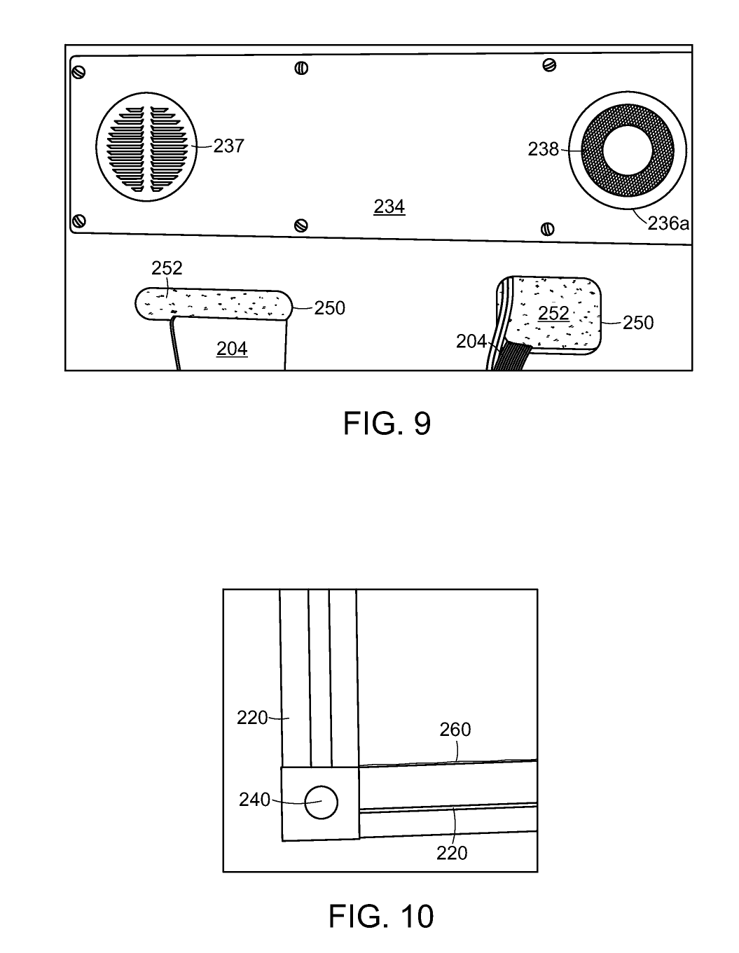

In further embodiments, after the rear wall 202 is assembled (as described above), the rear wall is further processed to create a ventilation pathway 230 so that air can flow from the exterior of the sound attenuation chamber 200 to the interior thereof. In more particular embodiments, and as shown more clearly in FIGS. 8(a),(b), the rear wall 202e from the side that would be external, is processed or machined so as to create a pathway 230 including a series of baffles 232. The series of baffles 232 allow air to pass laterally through the wall without compromising the sound attenuation properties of the chamber 200. As shown more clearly in FIG. 9, the baffles 232 are covered with an external piece 234, such as individual piece of Type I PVC. This external piece 234 includes one opening 236a with an attached fan 238 so air will move into the box. After the external piece 234 is attached, two other small circular openings on the inside and outside of the sound attenuation chamber 200 are provided and a mini-louver 237 is pressed into each of these openings to help muffle sound further.

The ventilation fan 238 allows an animal to stay in the sound attenuation chamber 200 for longer periods of time as compared to conventional sound attenuation chambers. Also the rear wall 202e is unique as compared to other conventional devices, in that there is not a direct opening between the inside and outside of the chamber. In the present invention, the ventilation or air coming from the outside externally must past laterally through a series of baffles in the middle layer of the rear wall. This allows the animal to remain properly ventilated while still maintaining the sound attenuation properties of the chamber.

The rear wall 202e also can be configured with one or more slots or openings to allow cables 204 (e.g., monitoring cables, control cables, power cables) to pass through from the outside to the interior of the sound attenuation chamber 200. These slots or openings 250 are then closed or sealed by inserting pieces 252 of polypropylene foam that is configured to expand to form a seal when inserted therein.

The sound attenuation chamber further includes a frame that is made up of the frame members 220 that are secured to each other to form the frame. The frame support members 220 are secured to each other using any of a number of techniques known to those skilled in the art and otherwise appropriate for the intended use. In more particular embodiments, the frame members 220 are secured to each other mechanically. The frame members 220 preferably are made from a material having sufficient strength so that sound attenuation chambers 200 can be stacked one upon each other and otherwise can support the walls and other loads that can occur during use of the sound attenuation chamber.

For example, as shown in FIG. 11 the sound attenuation chamber 200 can be configured so it includes a sliding drawer on which would be disposed an animal enclosure such as that described herein. Thus, the materials and structure of the frame members 220 when assembled and secured to each other would provide sufficient strength so as to support the drawer when it is extended outside of the chamber 200.

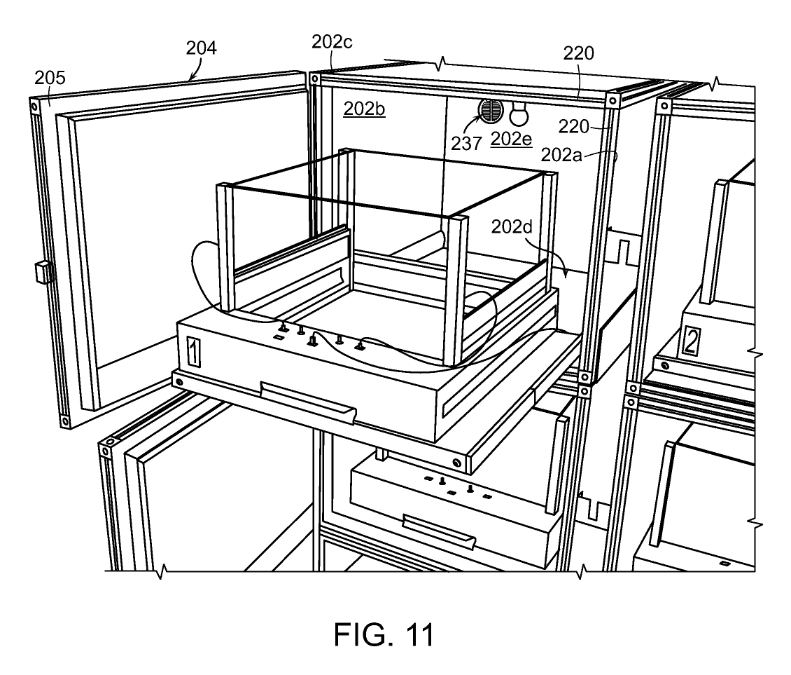

In further embodiments, and as shown more clearly in FIG. 10, the frame members when assembled together include a mechanism by which the sound attenuation chambers can be stacked upon each other and so as to prevent lateral movement of an upper chamber. In more specific illustrative embodiments, one or more apertures 240 are provided in the frame formed from the frame members 220, for example at each corner of the bottom and top surface of the chamber. A rod is inserted therein to prevent lateral movement of the upper chamber with respect to the lower chamber.

The layers wall forming the door further includes a surrounding frame work of frame members 220 that are joined to reach other to provide a supporting structure for the door. The door frame is hingeably coupled to the adjacent frame members 220 of the sides of the sound attenuation chamber 200 so that the door can be opened and closed. The door also includes a mechanism for keeping the door 200 shut, such as for example a magnetic latch as is known to those skilled in the art and a fixture (e.g., handle) that a user can grasp to open and close the door.

In further embodiments, the structure forming the sound attenuation chamber 200 after it has been fully assembled (e.g., with the frame and walls in place), is further configured so as to implement further measures to further attenuate sound transmission. All of the corners and edges (except those of the door) are covered with a silicon sealant 260 to further seal each box from external sound. Also, strips 262 of soft silicone foam rubber are placed on the exposed 45 degree edges of the wall panels that will meet with the door and/or on the exposed inside surface of the door frame 205. This allows the door to form a complete seal and preserves the sound attenuation properties of the box. Further, a sealing member 264 made of a resilient material such as santoprene foam rubber cord is pressed into slots provided in the inside edge of the surrounding door framework (e.g., the T-slots of the 80/20 aluminum extrusion) opposing the inside edge of the door so as to provide a further seal for the door.

In view of the foregoing it can be seen that the dimensions of a sound attenuation chamber 200 of the present invention are highly customizable, and may be scaled up or down to meet a researcher's experimental needs. In more particular illustrative embodiments, the frame members 220 making up the frame of the chamber are composed of cut-to-length pieces of 1″×1″ T-Slotted Aluminum Extrusion made by 80/20, Inc. The pieces are tapped with ¼″×20 holes in both ends so that the frame members form the frame (e.g., a frame having a cube formation) using 10 Series Square Tricorner Connectors (made by 80/20, Inc.) as the corner pieces. Four of such pieces also are assembled in a similar manner into a square formation to form the outer perimeter of the door 204. The door 204 is attached to the main box that makes up a part of the sound attenuation chamber 200 using 80/20 10 Series Heavy Duty Hinges. Also provided are an 80/20 Magnetic Door Catch to keep the door in place or closed and small plastic door handle that makes for easier opening. In yet further embodiments, the T-slots of the upper pieces of aluminum extrusion may be filled in with a T-slot cover, also made by 80/20. This may make the boxes easier to clean, especially if they are stacked.

Although the sound attenuation chambers 200 may not be considered as being completely sound-proof, the chambers are nonetheless capable of canceling out a vast majority of external or ambient noise. This makes the chambers 200 particularly useful for carrying out experiments with animals that are sensitive to sound (e.g., mice). In further embodiments, the walls are also constructed so as to be water proof, thereby preserving the sound attenuation properties despite potential spills of animal urine or laboratory solutions. Also, as compared to similar devices on the market, a sound attenuation chamber 200 of the present invention offers sound attenuation capabilities and customizability, yet are still relatively inexpensive.

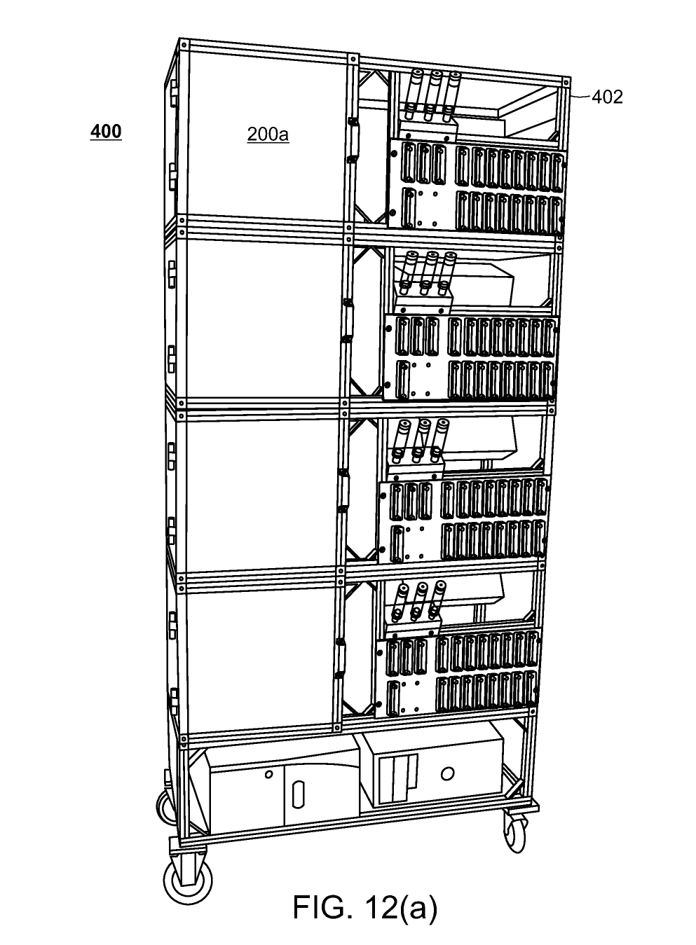

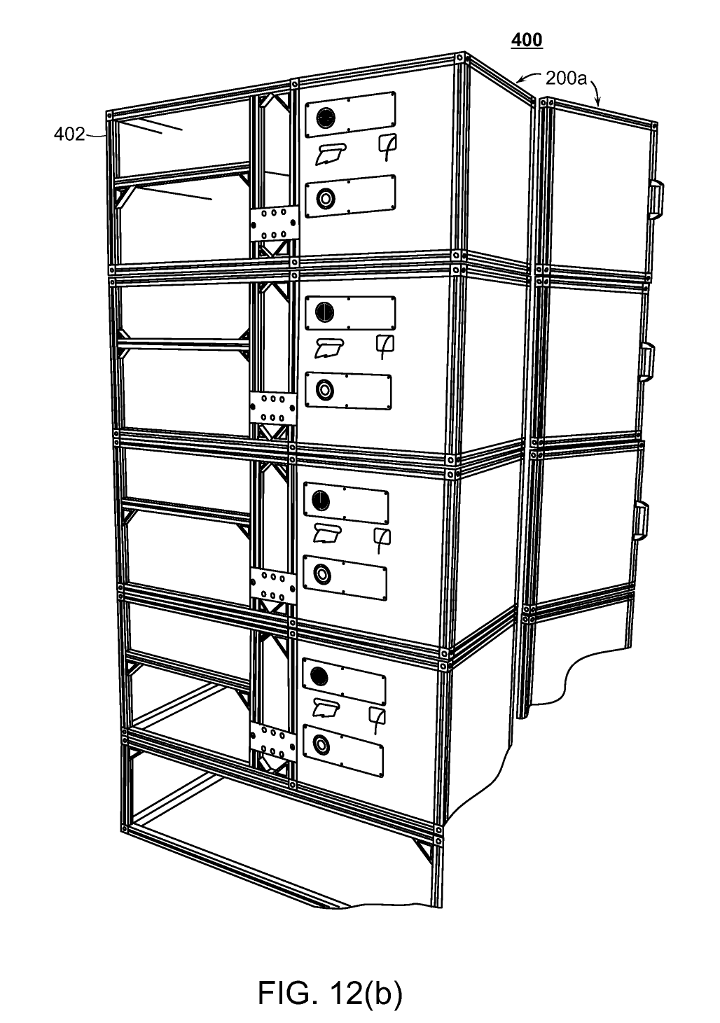

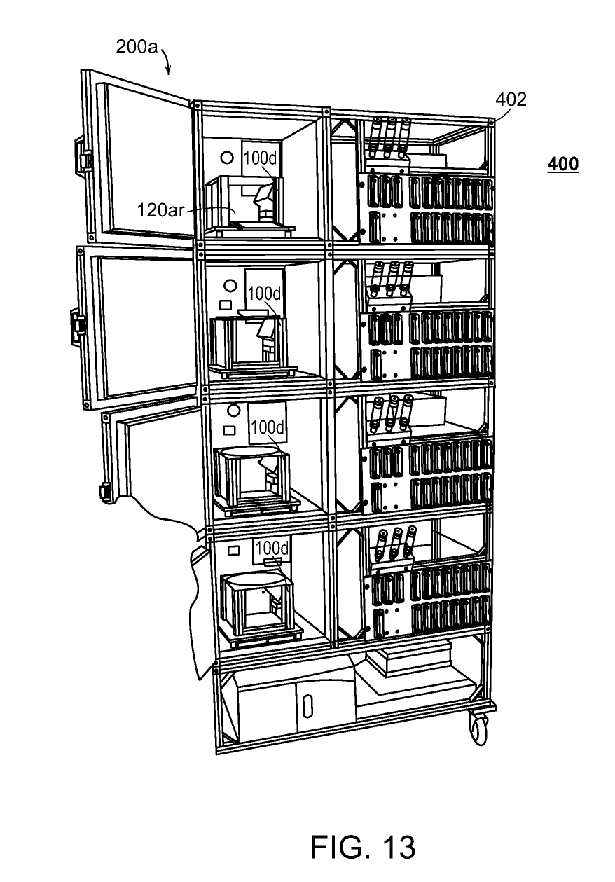

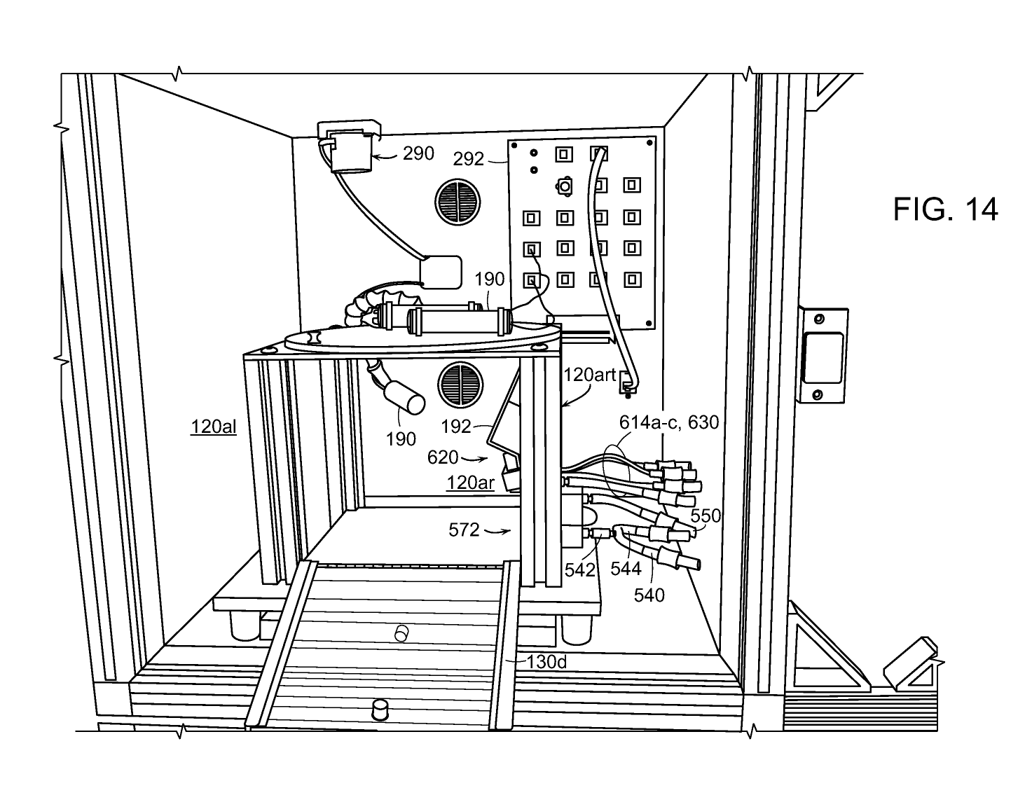

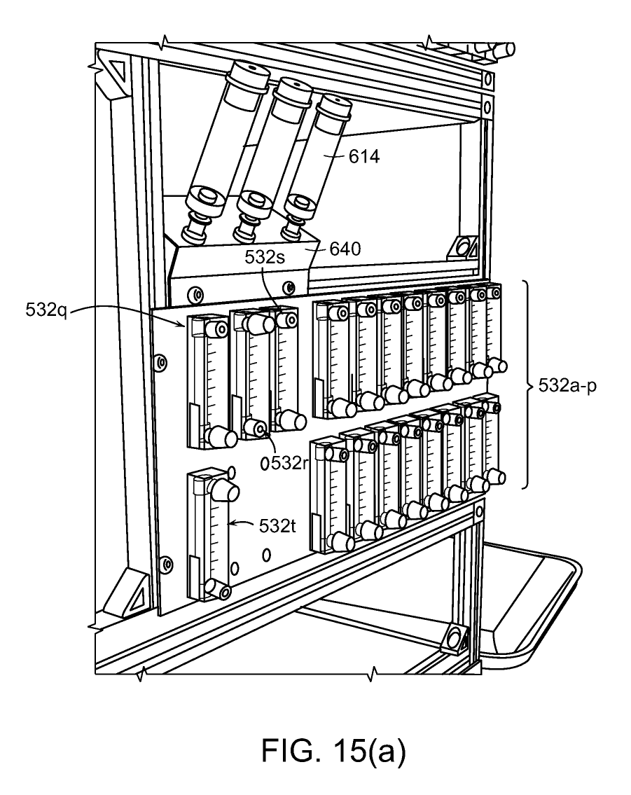

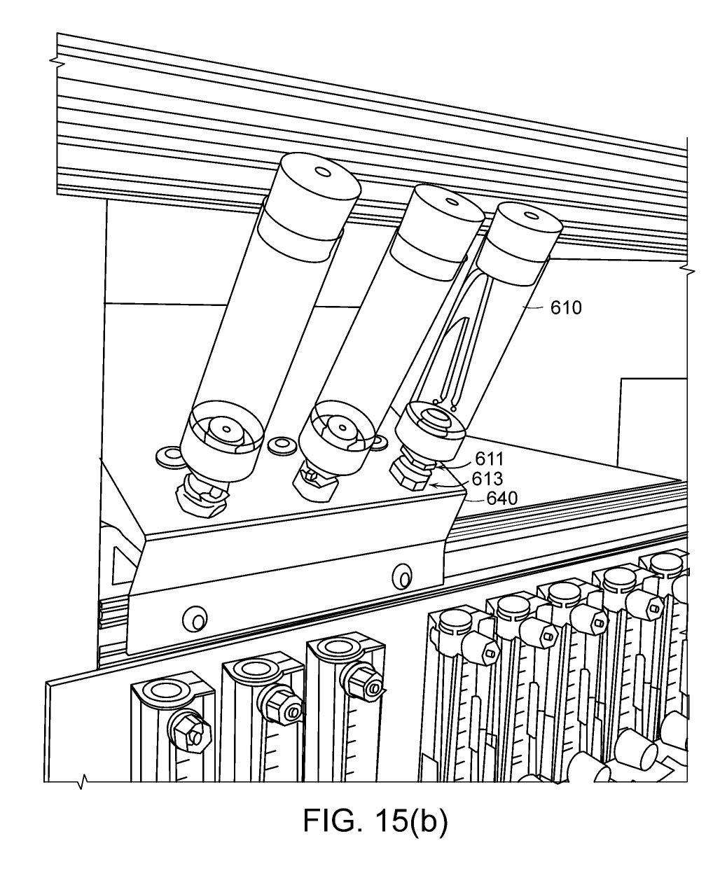

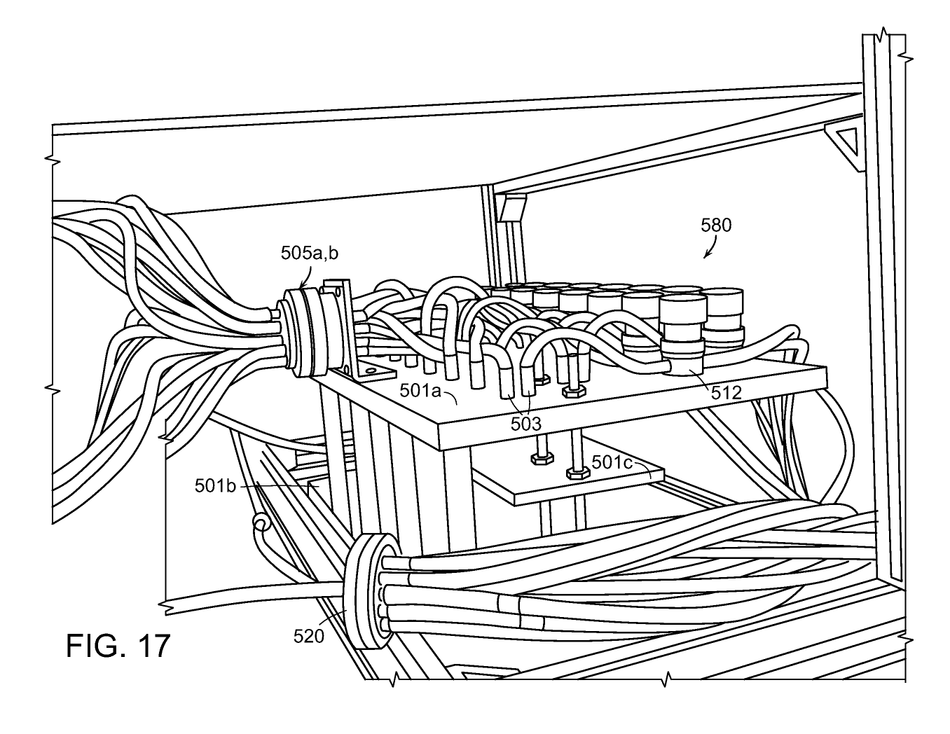

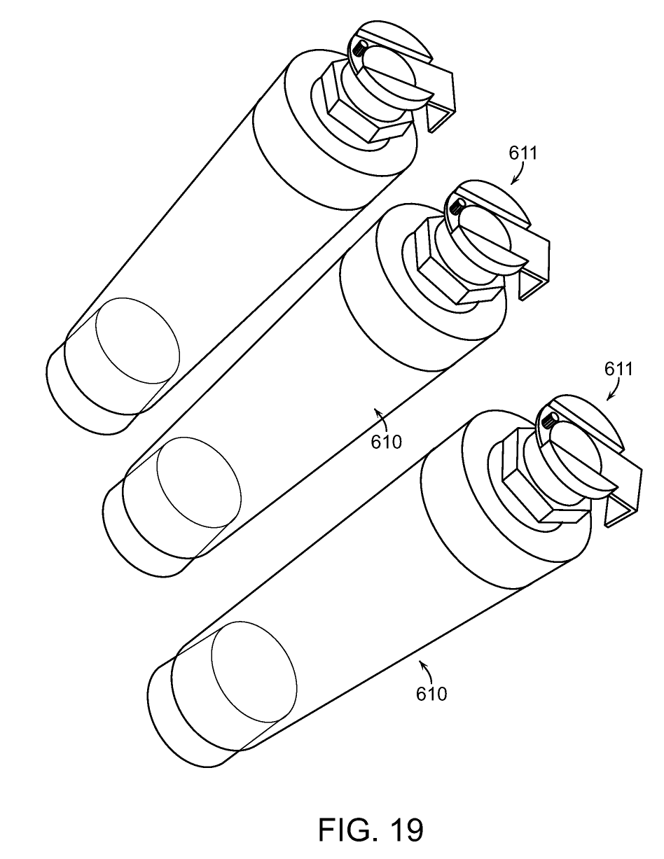

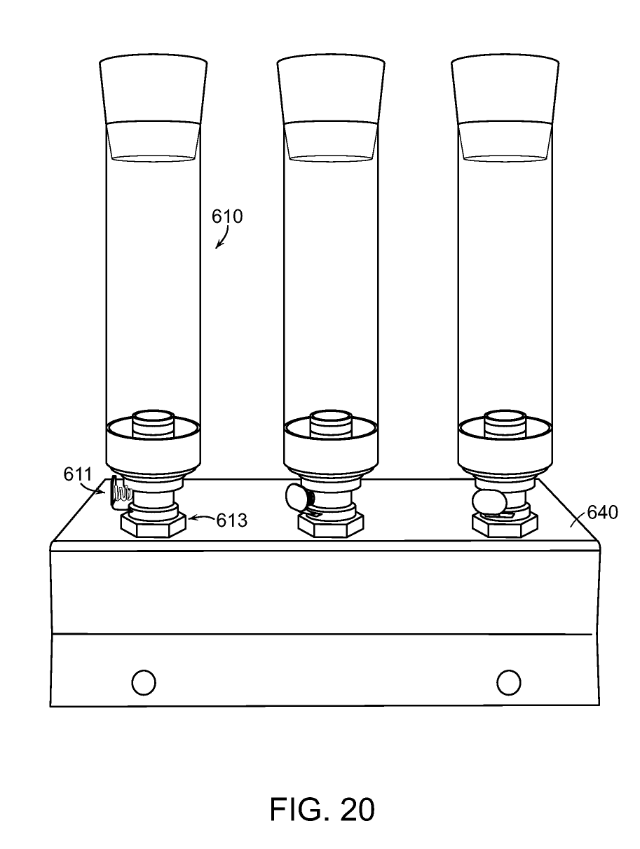

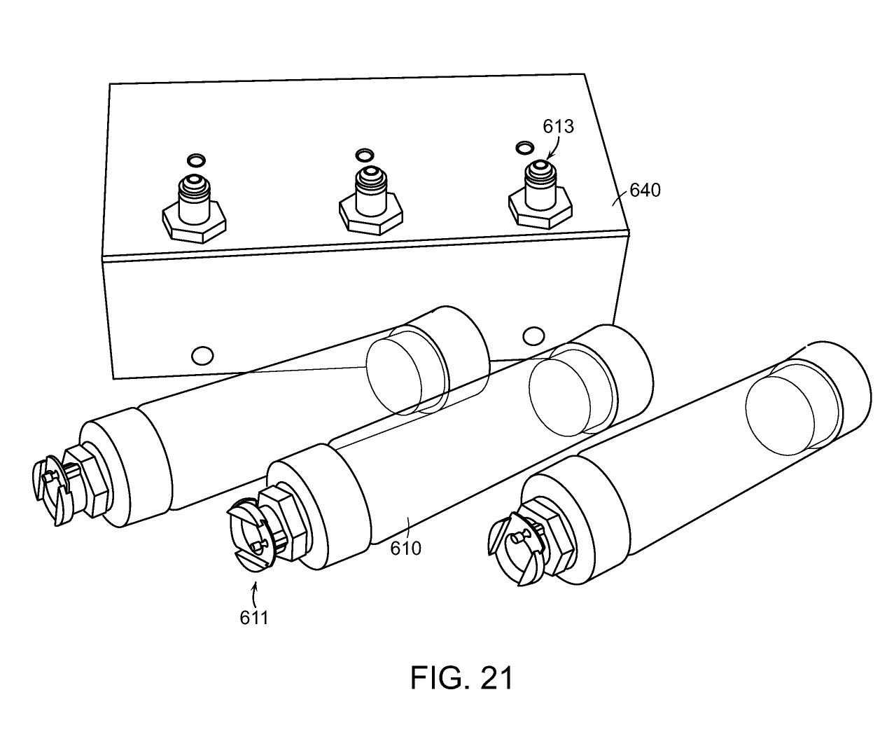

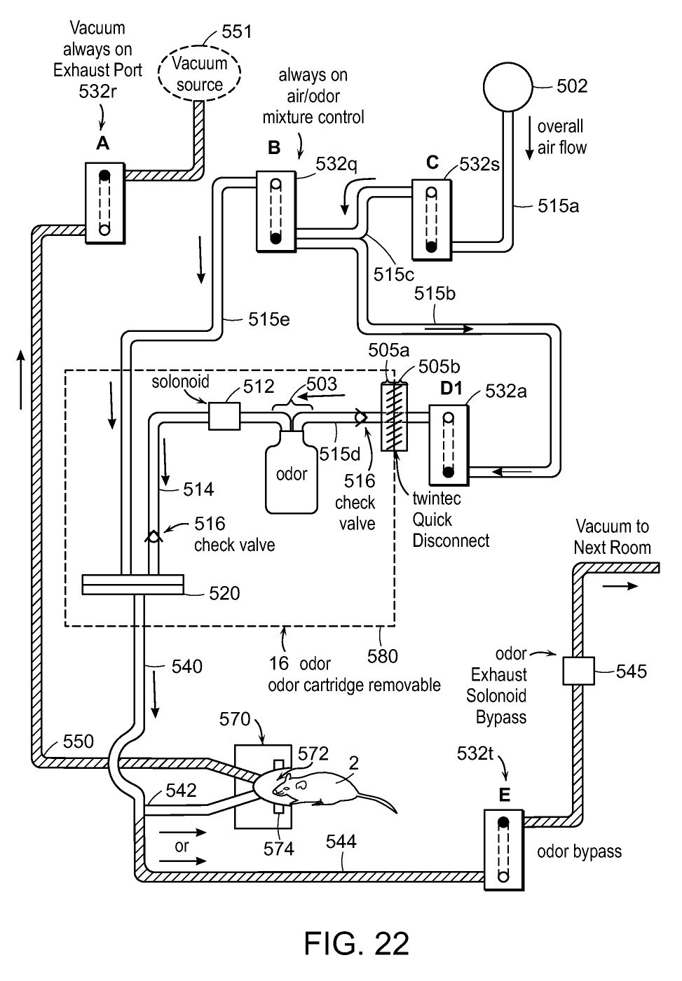

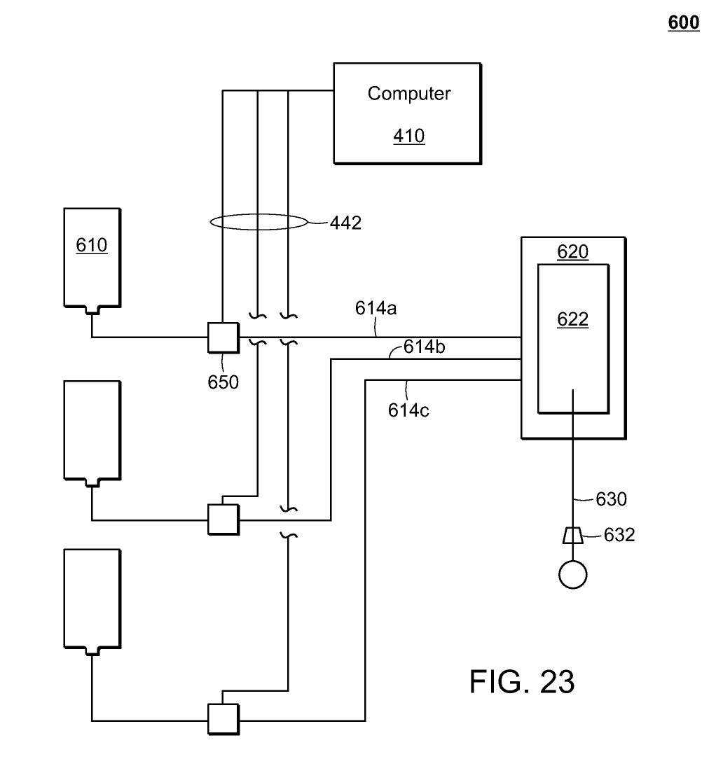

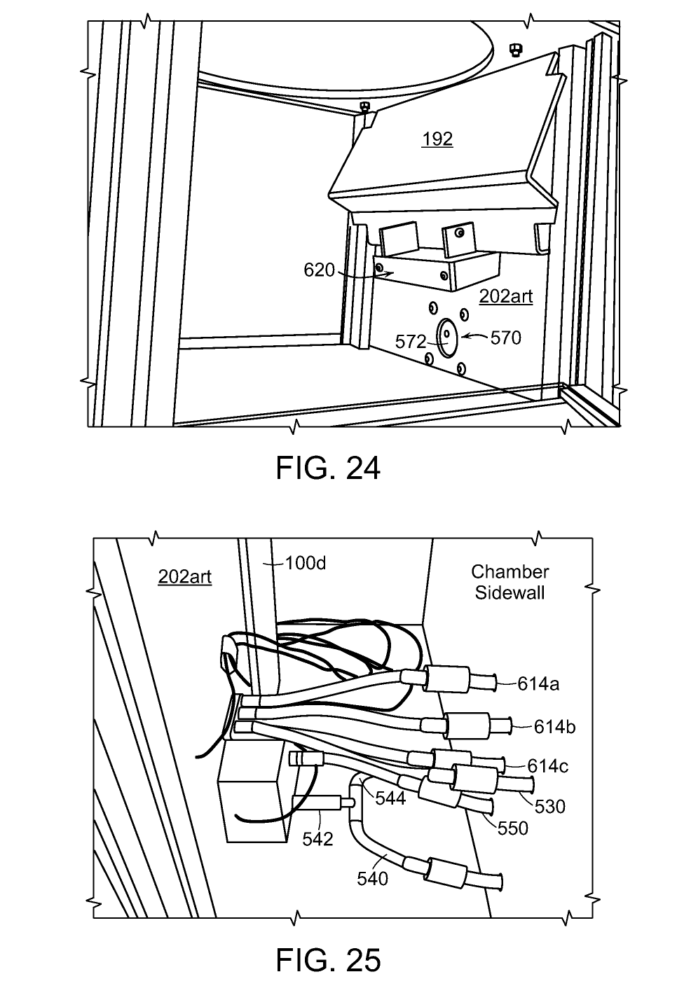

Many tasks used in animal behavioral testing require complicated training procedures to teach the animal to perform responses that they are unfamiliar with. This training is a time consuming aspect of certain types of experiments and is often not of particular interest to the researcher in and of itself. One such type of experiments utilizes the natural propensity of rodents to investigate novel aspects of their environment using their sense of smell. In such, experiments, a rodent is exposed to the smell of a gas or the like having a particular odor or smell which is then required to make a discrete behavioral response to such exposure. Referring now to FIGS. 12-21, 24-25 and 29-30 there are shown various views of an olfactory discrimination system 400 according to another aspect of the present invention. Referring also to FIGS. 22-23, there are shown schematic block diagram views of the sub-systems that deliver the smell and fluid to the rodent.

While the olfactory discrimination system 400 of the present invention is shown in use with a sound attenuation chamber 200 and an animal enclosure 100 described herein that are further configured or customized for performance of the function to be carried out in this type of experiment, this shall not be considered as limiting. It is within the scope of the present invention for the olfactory discrimination system and elements as described herein be adapted for use with any of number of other conventional devices.

In the illustrated embodiment, the olfactory discrimination system 400 of the present invention includes a plurality of sound attenuation chambers 200a in which is disposed an animal enclosure 100d; an odor delivery subsystem 500, a fluid delivery subsystem 600, all of which are mounted in a rack 402. For purposes of facilitating viewing by the user as well as access, the flow control valves/meters 532a-t of the odor delivery subsystem 500 and the fluid storage bottles 610 of the fluid delivery subsystem 600 are located on the front side of the olfactory discrimination system 400. Also, for access purposes, major portions of the odor delivery subsystem 500 are located so as to be accessed from the back side of the olfactory discrimination system 400. As also described herein, the odor cartridge 580 of the odor delivery sub-system 500 is designed so it can be removed as a unit thereby facilitating use, modification and operation of the olfactory discrimination system 400.

The animal enclosures 100d used for such testing are individually housed within specially designed sound attenuating chambers 200a, and feature a modular construction that allows the experimenter to easily modify the animal enclosure and/or sound attenuation chamber 200a beyond that shown to assess spatial discrimination (e.g., multiple wells, multiple locations), working memory (e.g., multiple odors; match and non-match to sample), and spatial working memory (e.g., multiple odors and wells). The olfactory discrimination system 400 described herein is used to screen for motor reaction time and signal detection.

The animal enclosure 100d used in this experiment is further customized as follows. The rear wall 120 ar and the door 130d, of the enclosure are made of a clear material (e.g., clear plastic material). The clear rear wall 120ar allows a small camera 190, such as small bullet camera, to see into the interior of the enclosure 100d. The camera 190 is coupled to external monitoring equipment, thereby allowing a researcher to observe behavior of the animal (e.g., mouse) in the enclosure 100d. The left wall 120a1 is made of an opaque plastic.

The roof or top 150d of the animal enclosure includes a removable circular plastic sheet such as that also shown in FIG. 3, that is held in place with “pop-in” connectors, thus allowing the ceiling to be moved or removed with minimal effort. The right wall 120art of the enclosure is customized so as to include a nose poke system as described hereinafter that forms a part of both the odor delivery system 500 and the fluid delivery system 600.

The nose poke system includes the odor structure 570 that includes an odor port 572 and an animal detection apparatus 574 that detects the presence of the animal 2 (e.g., the nose of a mouse) in the odor port. In illustrative embodiments, the structure of the odor structure is made in part from polycarbonate plastic. In an illustrative embodiment, the animal detection apparatus 574, embodies an infrared beam break system to detect when a mouse puts its nose inside the odor port 572. Such an infrared beam break system typically includes an IR light emitting diode and a corresponding IR light detector located in the odor port so that a signal is generated when the light beam is broken by the entry of an animal body part into the odor port. As is described hereinafter, the odor port 572 is connected via tubing to the odor bottles 510 outside of the sound attenuation chamber 200a. This provides a mechanism whereby odor is pulled from one of the odor bottles 510 into the odor port 572 within the animal enclosure 100d, and then vacuumed back out as short as a fraction of a second later as described further herein.

Above the odor port is located a fluid well structure 620, including a well 622 for receiving liquid, that is fluidly coupled to fluid bottles 610 that allow a fluid such as water, sucrose, quinine, or conceivably any other low viscosity liquid to be pulled into the well residing in the animal enclosure 100d, allow the animal to taste or drink it, and then drained away via a drain line 630. A guard 192 is provided above the fluid well (e.g., a aluminum guard bent at a high angle) to prevent the animal from climbing on the fluid well.

The sound attenuation chamber 200 as described herein is further modified as described hereinafter for this application. In this application one of the walls 202c forming the roof or top of the sound attenuation chamber 200a is arranged so as to include an attachment 290 for a screw-based light bulb in order to provide light for the animal when the experiment is running. Also, attached to the rear wall 202e is a Coulbourn ECB board 292, which is used for the optics system. This ECB board 292 can be used with a variety of other Coulbourn products, allowing a researcher to customize the chamber or animal enclosure further to meet his or her needs for a given experiment.

The right wall 202a of the sound attenuation chamber 200a includes a plurality of holes, more specifically seven holes through which tubing corresponding to various lines of the odor delivery sub-system 500 and the fluid delivery sub-system 600 are passed (e.g., drilled ⅛″ round holes arranged roughly in a pattern like that of an “I” beam). As described herein, this tubing provides a mechanism that allows the animal enclosure and functionalities thereof to couple with the odor, volume, and concentration controls on the outside of the sound attenuation chamber 200a.

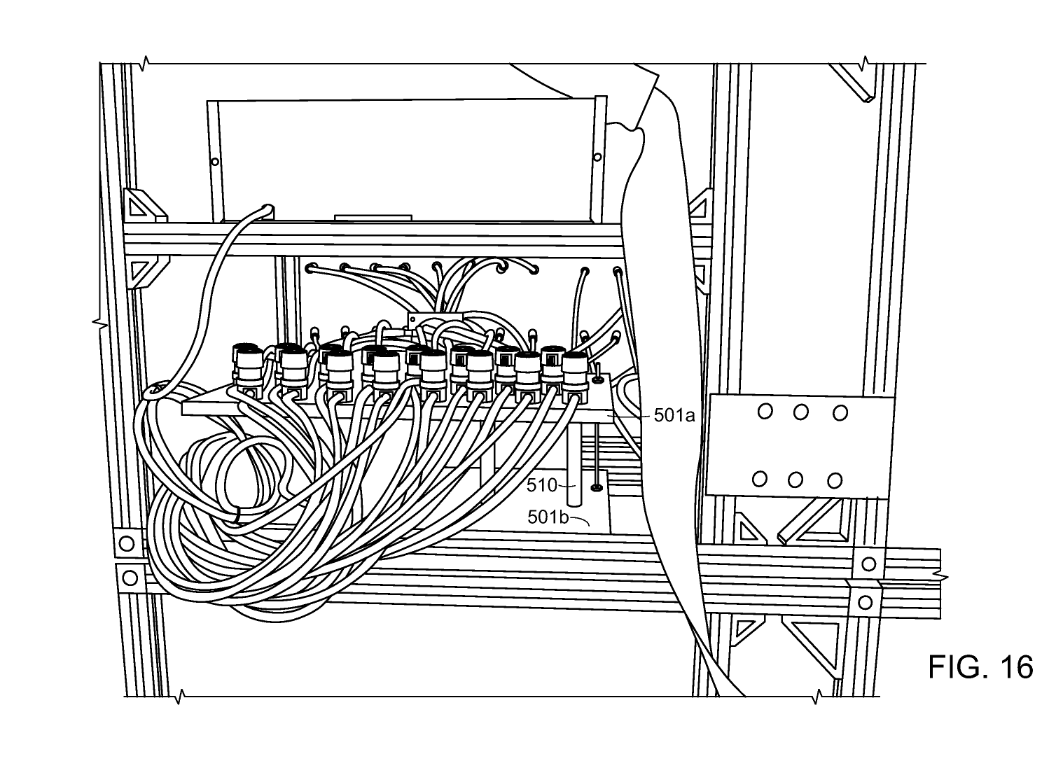

Now referring to the schematic block diagram of FIG. 22 and FIGS. 16-17, 24-25 and 29-30, the olfactory odor delivery subsystem 500 of the present invention is discussed in more detail. Such a subsystem 400 includes a plurality of gas cartridges or bottles 510 each partially filled with whatever chemicals the researcher chooses for creating or otherwise providing an odor. In particularly illustrative embodiments, there are provided sixteen 9.5 dram bottles. In further embodiments and as described in further detail herein, a pressure source 502 is fluidly coupled to each bottle 510 to assist with flow of the odor from the bottle to the odor port.

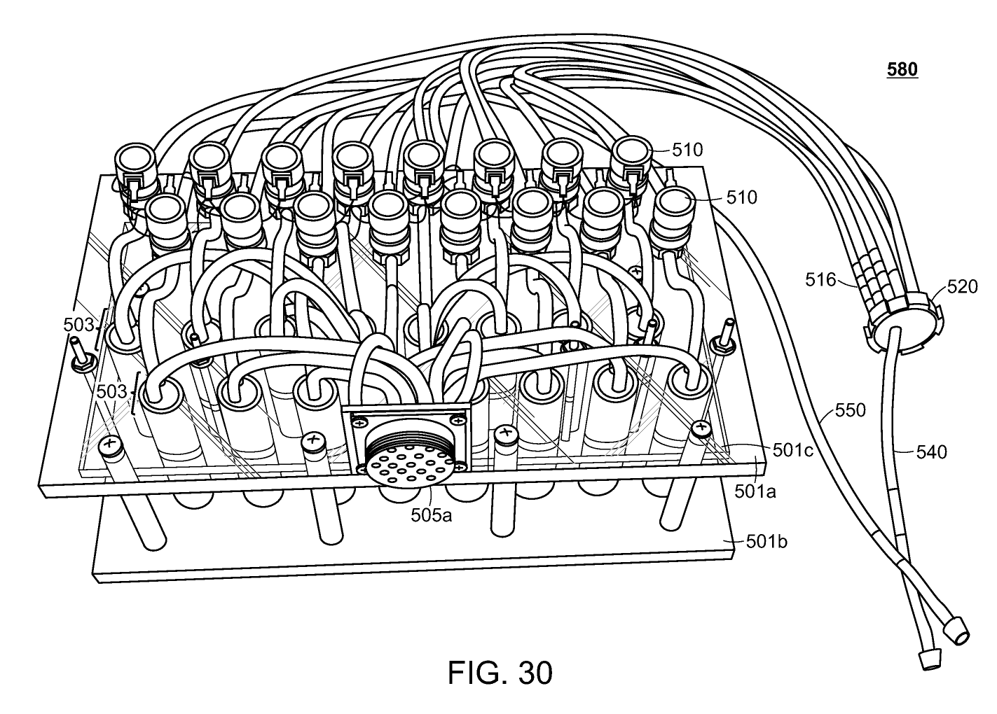

As shown more clearly in FIG. 30, the bottles 510 are arranged so as to be sandwiched between two pieces 501a,b, more specifically two pieces of polycarbonate. The lower piece 501b is machined so as to provide sixteen small circular indentations in which the bottles 510 rest, and a Buna-N 0-ring is placed within each indentation to allow the odor bottle assembly or odor assembly 580 to be compressed and sealed without the bottles breaking. The upper piece 501a is machined so that there are two small threaded thru-holes 503 above each bottle 510. Sixteen rings, each the size of a bottle top, is machined into the underside of the upper piece 501a around each duo of holes 503 and a Buna-N ring is fitted into each, allowing for each bottle to form an airtight seal with the upper piece. There are also attachment points for the solenoid valves 512, polycarbonate standoffs, and long attachment screws.

The assemblage of the foregoing parts along with other structure described herein, forms an odor cartridge 580 that is configured so as to be easily removed from the odor delivery sub-system 500 and easily replaced with another such odor cartridge whose bottles can contain different scents or odors from the cartridge being replaced. Thus, it is within the scope of the present invention, for a plurality of such odor cartridges 580 to be available for use with the olfactory discrimination system 400.

Each odor cartridge 580 is built using eight standoffs (e.g., to ensure the proper height and to keep it stable when the upper and lower bottom pieces 501a,b are compressed) and four long screws that run from the upper piece to the lower piece so as to allow these pieces to form an airtight seal around the bottles. In further embodiments, a smaller intermediary piece 501c with holes for each bottle 510 rests on nuts attached to the long screws. This intermediary piece 501c is placed roughly halfway between the upper and lower pieces 501a,b and is used to keep the bottles arranged in the proper configuration relative to one another.

The two small threaded thru-holes 503 above each bottle 510 are each filled with screw-in barb fittings. One barbed fitting for each bottle is connected to a Twintec “BH” Series socket piece 505a via a short length of polyurethane tubing. The other barbed fitting is connected using polyurethane tubing to a solenoid valve 512, one for each bottle 510, which all run via more polyurethane tubing to a central hub piece 520 that functions as a distribution manifold. A single tube 540 runs from the hub piece 520 through a wall of the sound attenuation chamber 200a and is coupled to the delivery line 542 that feeds the odor port 572. Thus, when the solenoid 512 for a corresponding bottle 510 is activated, the odor is eventually pulled from the corresponding bottle into the odor port within the animal enclosure 100d, which is described further herein.

One-way check valves 516 are located in the tubing between each solenoid valve and the hub piece 520, thus preventing odor from flowing backward from one bottle into another. Each of the solenoid valves 512 is electronically controlled by a computer 410 (e.g., a Coulbourn computer system) and the activation of the solenoids can be customized (e.g., opening times) to meet a researcher's needs.

The aforementioned Twintec “BH” Series socket piece 505a on the odor cartridge attaches to a matching screw-in plug piece 505b. This connection allows the odor cartridge 580 to be moved and switched with minimal effort. The matching plug piece 505b is attached via polyurethane tubing to a series of Minimaster flow control valves/meters 532a-p, one for each bottle 510, that allow for controlling and monitoring air flow through each bottle of the odor cartridge 580.

In more particular embodiments, air from the pressure source 502 is provided to an overall pressure air flow control valve/meter 532s via one airline 515a, that can be used to control the flow rate of air to the always on air-odor mixture control valve/meter 532q and it also can be used to provide an indication of the overall flow rate. The always on air-odor mixture control valve/meter 532q provides an air output to each of the bottle flow control/meter valves 532a-p via a second air line 515b and an air output that feeds to one of the input connections of the central hub piece 520 via a third airline 515c. In illustrative embodiments, the control valve/meter described herein are Minimaster flow meters that can be adjusted to control the material (e.g., air/, air/odor mixture) flowing there through.

Each of the bottle flow control/meter valves 532a-p is fluidly connected or coupled to a corresponding one of the bottles 510 through the Twintec “BH” Series socket piece connection 505a,b and through one of the two small thru-holes 503 above the corresponding bottle that forms in combination with tubing a fourth airline 515d. In further embodiments, a check valve 516 is located in the fourth air line 515d to forestall contamination by preventing reverse flow.

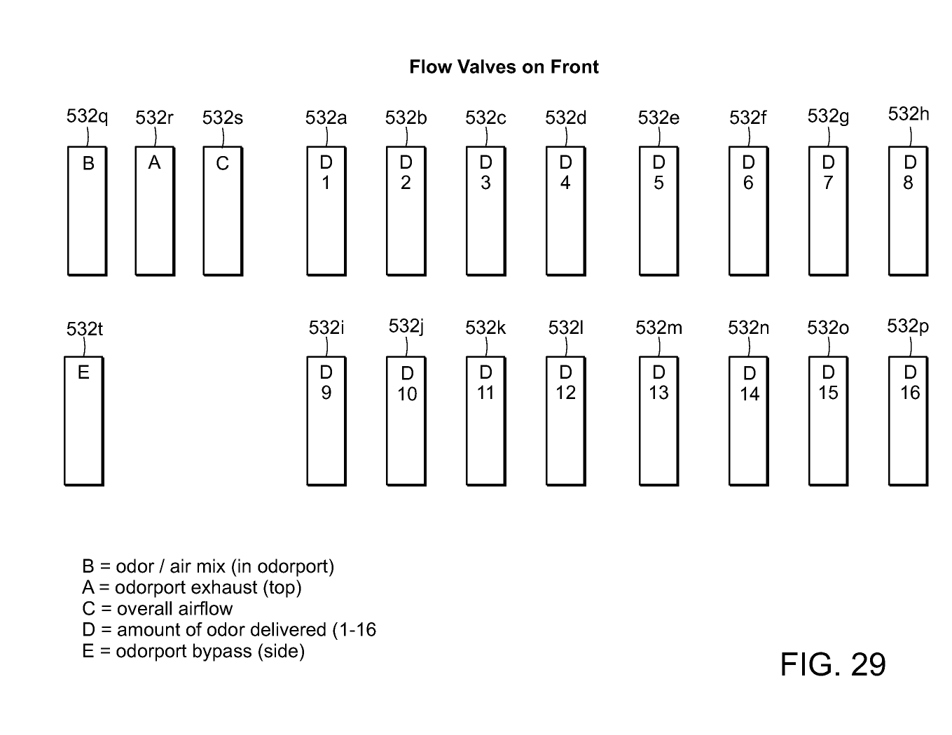

In operation, when odor is desired to be provided to the odor port 572, a solenoid valve 512 located in a respective bottle discharge line 514 for a corresponding bottle is opened, whereby an odor/air mixture flows from the bottle (i.e., out through the other of the two small thru-holes 503 above the corresponding bottle) through the respective discharge 514 and check valve 516 to another one of the input connection of the central hub 520. As there are sixteen bottles 510 and bottle flow control/meter valves 532a-p (see e.g., FIG. 29) in the illustrated embodiment, the central hub 520 is configured so to include enough input connections to couple with each respective bottle discharge line 514 and the air line 515e from the always on air-odor mixture control valve/meter 532q.

The always on air-odor mixture control valve/meter 532q is configured to carry out at least two functions. When a solenoid valve 512 for a desired bottle 510 is opened to allow an odor/air mixture to flow through a respective bottle discharge line 514, the air coming from the always on air-odor mixture control valve/meter 532q is used to further control the density, concentration or strength of the odor/air mixture flowing through the respective discharge line concentration which would be received in the odor port 272. In other words, the air coming from the always on air-odor mixture control valve/meter 532q mixes the odor/air mixture flowing through the respective discharge line 514 (e.g., in the central hub 520) and this mixture flows through the hub discharge line 540.

When the open solenoid 512 is thereafter closed, the air flowing from the always on air-odor mixture control valve/meter 532q continues to flow which, in combination with the bypass line 544 and/or the always on vacuum line 550 causes any odor/air mixture remaining in the downstream discharge pathway including down stream tubing and functionalities (e.g., central hub 520) to be flushed or cleansed therefrom. Thus, the odor delivery system automatically cleans itself following an odor discharge without requiring action by the experimenter (e.g., self-cleaning).

As indicated above, the odor delivery sub-system includes an always on vacuum line 550. The always on vacuum line is continuously, fluidly coupled the odor port 572 and to a vacuum source 551 via a vacuum exhaust port control valve/meter 532r so as to control the level of vacuum or suction being developed on the odor port 572. In particular illustrative embodiments, the vacuum being developed is controlled so that a positive pressure condition exists within the animal enclosure and within the sound attenuation chamber 200a.

The odor delivery sub-system also includes a bypass line 544 that is fluidly coupled at one end to the delivery line 542 and the hub discharge line 540 and at the other end to a vacuum source that is preferably located in a room remote from the room in which testing is being done. The bypass line 544 is configured to include a bypass line control valve/meter 532t and an odor exhaust bypass solenoid 545 that selectively couples and decouples the bypass line to the vacuum source.

In further embodiments of the present invention, each of the solenoids 512, 545 are controlled by a computer 410 (FIG. 23) such as a Coulbourn computer system. The computer controls the solenoids so that the solenoid 512 corresponding to the odor to be delivered to the odor port 572 is opened and remains open for the desired duration of time and that the odor exhaust bypass solenoid is controlled as described hereinafter to facilitate drawing the odor/air mixture to the odor port and thereafter closed so the so-drawn odor/air mixture is drawn into the odor port 572 so that it can be sensed by the animal.

It should be noted while a single bottle pathway of a odor cartridge 500 is illustrated in FIG. 22 for clarity; this shall not be considered a limitation as it is within the scope of the present invention for the odor cartridge to be configured so as to include “N” such bottle pathways, where “N” is an integer greater than one and in specific illustrative embodiments N=16. This also shall not be considered a limitation as N is adjustable to fit the intended uses and functions of the olfactory discrimination system such as how many different odors that can be selected to be tested at any one time. Thus, N can be greater than 16 as well as being less than sixteen.

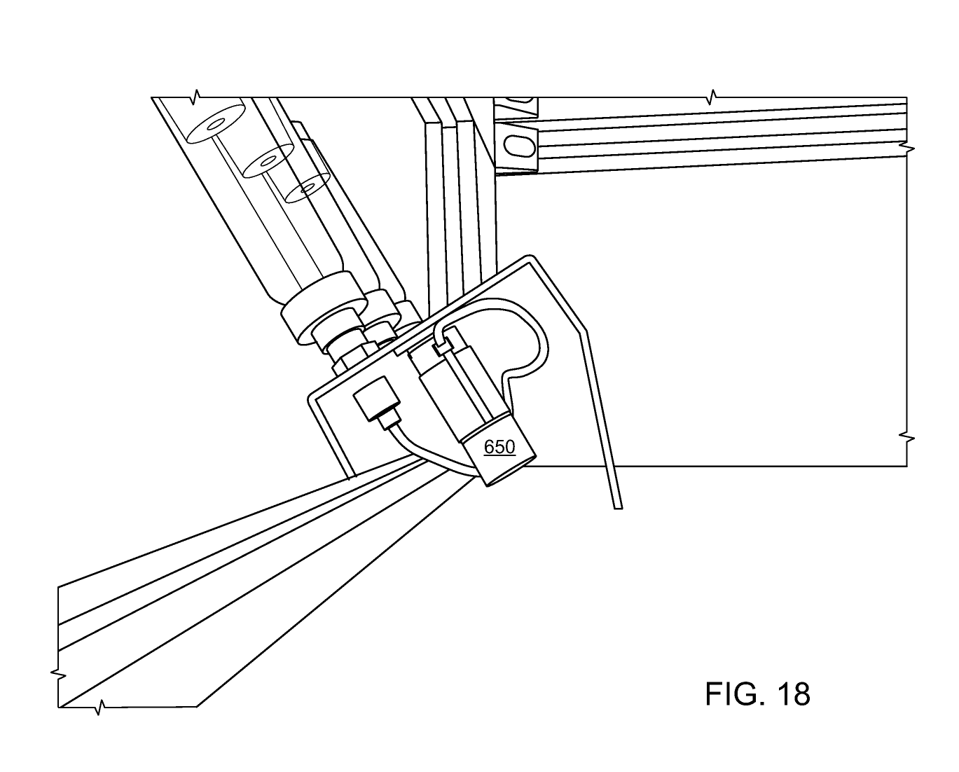

Now referring to the schematic block diagram of FIG. 23 and FIGS. 18-21, and 24-25, the fluid delivery sub-system 600 of the present invention is discussed in more detail. The fluid delivery sub-system 600, more specifically functionalities thereof, are also controlled by the computer (e.g., a Coulbourn computer system). The fluid reservoirs are stored in bottles 610 (e.g., customized 9.5 dram bottles), each with a female quick-disconnect shutoff fitting 611, which allows the bottles to be moved and replaced without spillage. These fittings 611 are able to connect to their equivalent male fittings 613 attached to a mounting bracket 640 (e.g., aluminum mounting bracket. In illustrative embodiments, the bracket 640 holds up to three bottles at once. As indicated herein, it is within the scope of the present invention to expand the number of bottles available.

Three valves 650 (e.g., 075P Series Pinch Valves from Western Analytical) also are attached to this bracket 640, one for each bottle 610. When the valves 650 are activated by the computer 410, the valves release the 1/16″ tubing 614a-c running through them, thereby allowing fluid to drain via gravity from the fluid reservoir or bottle 610, through the side wall of the sound attenuating chamber 200a and thence into the well 622 inside of the animal enclosure 100d. Another valve 632 acts as a control for the central drain line 630 located in the animal enclosure. It is within the scope of the present invention for the bottles be under pressure or a pump be provided to facilitate the flow of the fluid from the bottle to the well 622. It also is within the scope of the present invention for a pump or a suction source be fluidly coupled to the drain line 630 to facilitate draining of fluid from the well 622.

The olfactory discrimination system 400 of the present invention features modular construction on several levels allowing for future adaptations and functions. Individual units of the system can be moved/removed to allow for different configurations to suit the researchers needs. For example, a unit can be removed from the system and set up on a bench top to allow for electrophysiological recording. Additionally, the walls of the animal enclosure chamber can be removed and replaced to meet different experimental demands. For example, multiple odor ports and/or fluid reward delivery wells can be inserted in the enclosure to add a spatial component to research protocols.

The use or operation of the olfactory discrimination system of the present invention can be understood from reference to the following discussion and with reference to above-identified figures. Sixteen odors provide in bottles 510 are sealed in interchangeable cartridges 580 allowing for the delivery of any possible combination of odorants. Solenoid valves 512, 545 on the system control the odor/air mixture allowing for the delivery of different concentrations of odorants. The odor/air mixture delivery is nearly instantaneous due to the bypass line 554.

During an experiment, the experimenter selects an odor from one of bottles 510 to present to the animal. That odor is then fed via the hub discharge line 540 from the hub piece 520 into the bypass line 544 directly under the odor port 572. Delivery of the odor delivery is then accomplished by turning off the bypass line 544 (i.e., closing the odor exhaust bypass solenoid 545) thereby forcing the odor/air mixture via the delivery line 542 into the odor port 572. The delivered odor/air mixture is pulled into and thence out of the odor port 572 by the top vacuum line 550 that is operably coupled to the top of the odor port. As the odor delivery sub-system 500 can deliver odors in a time-sensitive manner, experimenters can deliver multiple short-duration puffs of different odors which can be incorporated into a working memory task. Because conventional systems do not incorporate such an odor bypass feature, they are not certain to deliver odor in a time-sensitive manner and thus cannot assess working memory.

The odor is localized to the odor port 572 due to a combination of several features. Additional valves control the overall flow of air/odor mixture into the port and the overall vacuum flow of air/odor mixture out of the port. In concert with the integrated sound attenuation chamber 200a that are specially designed and sealed (also attenuate sound) and specifically calibrated ventilation fans, the odor delivery sub-system 500 of the present invention ensures that odor should not escape the odor port into the animal enclosure. Thus, pollution of the animal enclosure is thereby avoided.

Also, the vacuum lines 544, 550 run out of the testing room to a vacuum source that is located remote from the testing room and is ultimately pumped out of the building. This ensures that the odor leaving the system does not escape into the testing room. Because conventional systems do not incorporate these aspects, these other systems cannot assure that odorant is not contaminating the testing area and thus also the animal enclosure; and therefore one cannot be sure that the animal is only sampling the odor selected by the experimenter in a time-sensitive manner nor can they be sure that other animals in the testing room are not sampling waste odors.

As to the fluid delivery sub-system 600, this sub-system can deliver a precise amount of up to three different fluids at any time. This feature is expandable to six fluids and is not available on any conventional system. The fluids are delivered from easy-to-load quick-change bottles 610 and the entire sub-system is self-cleaning (also a feature not found on conventional systems).

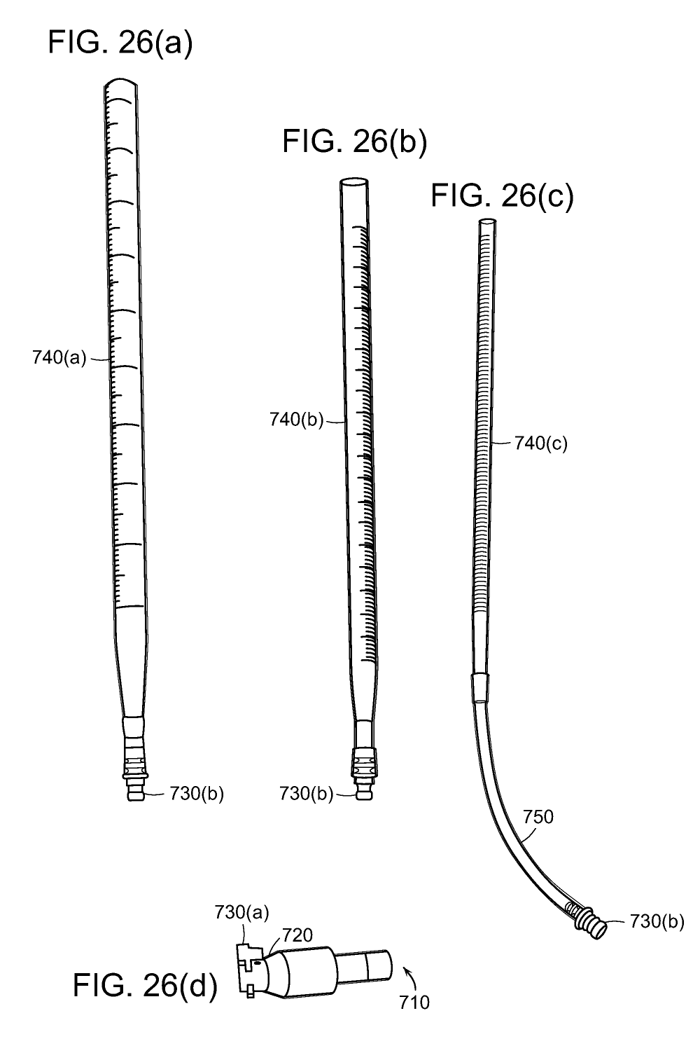

Referring now to FIGS. 26-28 there are shown various views of capillary lickers 700 or components thereof according to another aspect of the present invention. Such a capillary licker 700 can be used in combination with the any of the animal enclosures 100a-d described herein as well as with any of a number of other such enclosures known to those skilled in the art. Such a capillary licker also can be used in combination with the sound attenuation chamber 200 and/or olfactory discrimination system 400 as described herein.

In illustrative embodiments, a capillary licker 700 according to the present invention includes a water valve 710 (e.g., Lixit L-130 Water Valve), an adaptor piece 720, a disconnect piece 730 (e.g., Air Logic Miniature Quick Disconnect, ⅛″) and an indexed storage device 740a-c (e.g., volumetric serological pipet). In further embodiments, such a capillary licker 700 is configurable to include tubing (e.g., ⅛″ ID polyurethane tubing) to interconnect the valve assembly and the pipet. In the present invention, the adapter piece is used to attach the water valve 710 to the disconnect piece 730, more specifically either the male part of disconnect piece (hereinafter male disconnect piece 730a) or the female part of disconnect piece (hereinafter female disconnect piece 730b) so as to thereby create a leak-proof system.

The following is an illustrative description of making such an adapter piece 720 for use in a particular application. It should be recognized that it is well within the skill of those in the art to adapt the following for use in making different size adapters pieces for connection with water valves or disconnects having different end connection details.

An adaptor piece 720 for interconnecting a Lixit L-130 Water Valve to an Air Logic Miniature Quick Disconnect, ⅛″ is built using a ½″ diameter piece of polyetherimide (Ultem) rod, cut to 0.845″ in length. One end is drilled and tapped with a ⅛×27 NPT pipe tap to a depth of 0.590″. The opposite end is drilled and tapped with a 10×32 tap so that it opens into the opposite end. The end with the 10×32 hole is tapered down starting 0.255″ from the edge. The diameter of the end with the 10×32 hole should be tapered down to a diameter of 0.356″.

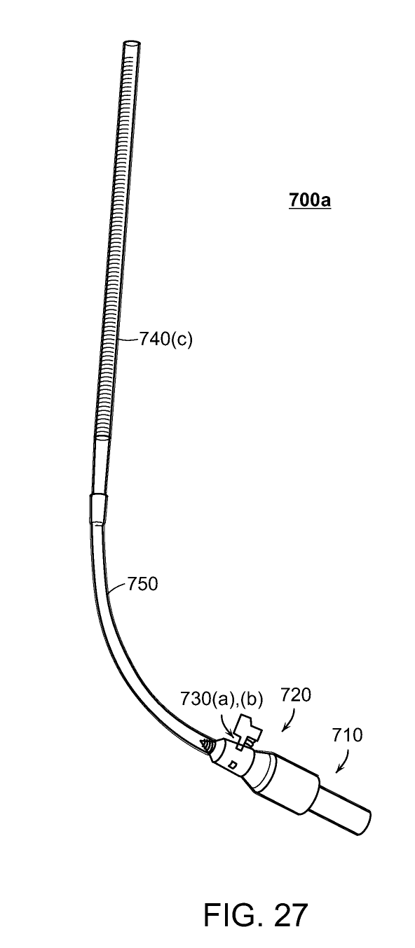

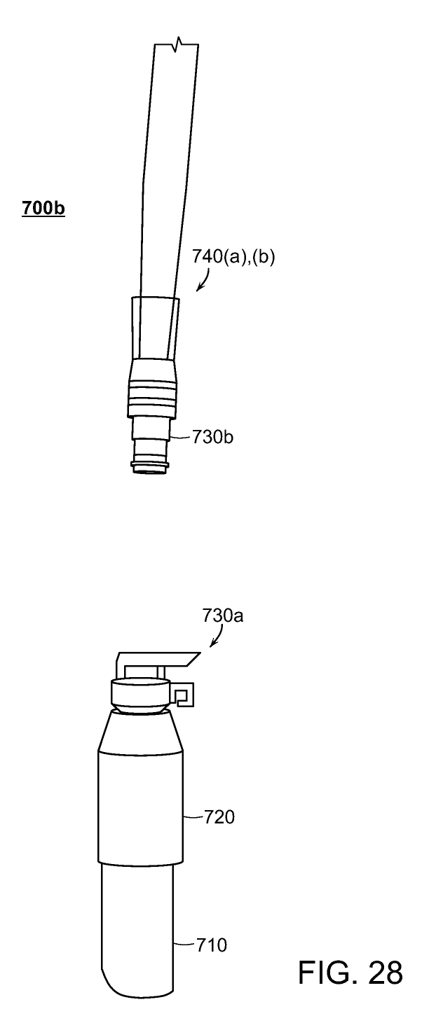

The Lixit L-130 Water Valve 710 is then screwed into the ⅛×27 NPT end of the so constructed adapter piece 720 and the female Air Logic Miniature Quick Disconnect 730b is screwed into the 10×32 end of the adapter piece. As shown in FIGS. 26(c) and 27, a piece of tubing 750 (e.g., polyurethane tubing) can be attached the barbed end of the male quick disconnect 730a, and this tubing is attached to the pipet 740(c). As shown in FIGS. 26(a), 26(b) and 28, the outlet end of the indexed storage device 740(a),(b) can be of such a design that it can be coupled to the male disconnect piece 730a and thus tubing is not involved in the construction of these capillary lickers 700(a),(b).

The use of the capillary licker 700 of the present invention can be understood from the following discussion and with reference to the foregoing discussion and the referenced drawing figures. The indexed storage device 740 is located within an animal enclosure such as that described herein. The researcher fills the indexed storage device 740 with a desired quantity of liquid before or after the storage device is located within the animal enclosure. The animal drinks the fluid using the Lixit water valve over the course of an experiment. The researcher reads how much fluid has been consumed by examining the level of water versus the indexed markings on the storage device 740 (e.g., markings on a volumetric pipet).

As illustrated in FIGS. 26(a)-(c), the indexed storage device 740 can be of any size that is suitable for the intended use and experiment. More specifically, the capillary licker 700 of the present invention is such that it is easily configurable to use any one of a number of multiple different sizes of storage devices or pipets, thus allowing researchers to run experiments longer, with larger animals, or with more available fluid.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. An animal enclosure comprising:
a frame including a plurality of scalable frame members that are interconnected to each other;
a plurality of wall members;
wherein each of the plurality of scalable frame members includes a connecting mechanism configured so as to releasably secure an end portion of an adjacent wall member;
wherein each wall member is secured to an adjacent pair of frame members so as to thereby form a wall of the animal enclosure.

2. A sound attenuation chamber comprising:
a frame including a plurality of scalable frame members that are interconnected to each other;
a plurality of panel members;
wherein each of the plurality of scalable frame members includes a connecting mechanism configured so as to secure an end portion of a panel member;
wherein each of the plurality of panel members is configured so as to include a plurality of layers of materials having different densities that when attached to each other creates a panel that attenuates sound external to the chamber.

3. The sound attenuation chamber of claim 2, wherein each of said plurality of panels is configured to include at least three layers of material, the density of each layer being different from the other layers.

4. An olfactory discrimination system for selectively exposing an animal to one of a plurality of odors at a time; said system comprising:
an odor delivery subsystem, wherein the odor delivery sub-system includes:
a plurality of bottles, each containing a material(s) for generating an odor;
a delivery device configured to selectively deliver a specific odor from one of the plurality of bottles to the animal,
the delivery device including a delivery line and a bypass line operably coupled to the delivery line, and
wherein the delivery device is configured so that the bypass line is selectively coupled to a vacuum source so flow of the odor through the delivery line occurs when the bypass line is fluidly coupled to the vacuum source and so the odor is delivered to the animal from the delivery line when the bypass line is fluidly de-coupled from the vacuum source.

5. The olfactory discrimination system of claim 4, further comprising:
a means for providing a continuous source of gas, where said continuous gas source means is fluidly coupled to the delivery line; and
wherein the delivery device is further configured so that
said continuous gas source means is coupled to the delivery line when the bypass line is open when flow of odor through the delivery line occurs and when the odor is being delivered to the animal, and
so that the gas continues to flow through the delivery line after flow of the odor to the animal is discontinued.

6. The olfactory discrimination system of claim 4, further comprising N bottles, where N is an integer greater than 2.

7. The olfactory discrimination system of claim 4, further comprising N bottles, where N is 16.

8. The olfactory discrimination system of claim 4, further comprising:
a fluid delivery subsystem, wherein the fluid delivery sub-system includes:
a plurality of bottles, each containing a different fluid;
a fluid delivery device configured to selectively deliver a specific fluid from one of the plurality of bottles to a watering device for the animal; and
wherein the delivery device includes:
a plurality of delivery lines one for each bottle,
a plurality of control devices one of said plurality of control devices being operably coupled to a respective one of the delivery lines, and
a controller operably coupled to each of the control devices and which is configured so as to cause the respective control device, corresponding to the bottle having the fluid to be delivered, to operate so as to allow the fluid to flow from the bottle to the watering device.

9. An apparatus for measuring water consumed by an animal over time comprising:
a watering device;
an indexed storage device configured to store a fluid and to include gradations representative of an amount of fluid in therein; and
a means for fluidly coupling the watering device to the indexed storage device.

10. The measuring apparatus of claim 9, wherein said means for fluidly coupling includes an adaptor configured to couple with an end of the watering device and an end of the indexed storage device.

11. The measuring apparatus of claim 9, further comprising a quick disconnect including a first part and a second part that are selectively coupled and de-coupled from each other, and wherein the means for coupling includes an adapter configured to selectively couple with an end of the watering device and one of an end of the first part or second part.

12. A method for determining an amount of fluid consumed by an animal comprising the steps of:
providing an animal watering apparatus including an indexed storage device configured to store a fluid and to include gradations representative of an amount of fluid in therein;
visually observing the indexed storage device and determining therefrom an amount of fluid consumed by the animal.

13. The method of claim 12, wherein said visually observing does not involve the touching of the indexed storage device by a user.

14. A method for selectively exposing an animal to one of a plurality of odors at a time, said method comprising the steps of:
providing an odor delivery subsystem, wherein the odor delivery sub-system includes:
a plurality of bottles, each containing a material(s) for generating an odor,
a delivery device configured to selectively deliver a specific odor from one of the plurality of bottles to the animal, and
the delivery device including a delivery line and a bypass line operably coupled to the delivery line, and
coupling the bypass line to a vacuum source so flow of the odor through the delivery line occurs, and
decoupling the bypass line from the vacuum source so the odor is delivered to the animal from the delivery line when the bypass line is fluidly de-coupled from the vacuum source.

15. The method of claim 14, further comprising the steps of
providing a fluid delivery subsystem that includes:
a plurality of bottles, each containing a different fluid;
a fluid delivery device configured to selectively deliver a specific fluid from one of the plurality of bottles to a watering device for the animal; and
operating the fluid delivery device so the fluid in the bottle having the fluid to be delivered flows from the bottle to the animal watering device.

16. A method for making a sound attenuation chamber comprising the step of:
creating a frame from a plurality of scalable frame members that are interconnected to each other;
providing a plurality of panel members, each of the plurality of panel members is configured so as to include a plurality of layers of materials having different densities that when attached to each other creates a panel that attenuates sound external to the chamber; and
connecting each of the plurality of frame members to adjacent pairs of scalable frame members so as to form at least five walls of the chamber.
